(19) United States
(12) Patent Application Publication
(10) Pub. No.: US 2026/0200257 A1
(43) Pub. Date: Jul. 16, 2026

(54) METHOD FOR PRODUCING A MULTILAYER ELEMENT, AND MULTILAYER ELEMENT

(71) Applicants: LEONHARD KURZ Stiftung & Co. KG, Fürth (DE); OVD Kinegram AG, Zug (CH)

(72) Inventors: Violetta OLSZOWKA, Fürth (DE); Benjamin HASSE, Fürth (DE); Harald WALTER, Zug (CH); Johannes HOLZWARTH, Fürth (DE)

(21) Appl. No.: 19/132,433

(22) PCT Filed: Nov. 21, 2023
(86) PCT No.: PCT/EP2023/082570

§ 371 Date: May 23, 2025

(30) Foreign Application Priority Data
Nov. 28, 2022 (DE) 10 2022 131 373.5

(51) Int. Cl. B42D 25/324; B32B 3/30; B32B 7/023; B32B 7/12; B32B 27/08; B42D 25/373

(52) U.S. Cl. CPC B42D 25/324; B32B 3/30; B32B 7/023; B32B 7/12; B32B 27/08; B42D 25/373; B32B 2255/10; B32B 2255/205; B32B 2307/404; B32B 2307/7376; B32B 2425/00

(57) ABSTRACT

A method for producing a multilayer body, and a multilayer body having a microlens array (60) in a microlens region (6), wherein, in the microlens region, structure-based color effects are provided in a first region (1) by means of first relief structures (10), and a partial metal layer (100) demetallized by means of second relief structures (20) used as a mask is arranged in a second region (2).

The invention relates to a method for producing a multilayer body, in particular security element, and to a multilayer body, in particular a security element.

It is known for security elements to be provided with optically variable effects in order to increase protection against forgery. For this purpose, use is made inter alia of microlens arrays in combination with microimages. For example, different images can be depicted through the microlenses depending on the viewing angle, which images are made up of magnified parts of a plurality of microimages. The interaction of the individual microimages and in particular the magnification effects means that a precisely angled arrangement of the microimages relative to the microlens array, an in-register arrangement of the microimages relative to the microlens array, a high resolution, and high edge definition are of major importance. Production methods for the microimages are however subject to limitations in this regard. For example, high register accuracy or edge definition can be achieved by means of an etching method for generating a metal layer that delineates the microimages. To protect the metal layer during the etching operation, a mask may be applied to the metal layer. Here, the resolution is however subject to limitations depending on the production method.

It is an object of the invention to provide an improved method for producing a multilayer body, and an improved multilayer body.

Said object is achieved by a method according to claim 1, a multilayer body according to claim 43 and a security document according to claim 55.

The method for producing a multilayer body, in particular a security element, comprises the following steps:
Providing a spacer layer. In particular, a carrier ply is used as a spacer layer. The spacer layer has a first side and a second side situated opposite the first side.
Providing or generating a microlens array in a microlens region, wherein the microlens array is arranged on the first side of the spacer layer.
Providing or generating a replication layer on the second side of the spacer layer.
Providing or generating first relief structures in the replication layer, wherein the first relief structures are assigned to a plurality of first image elements. The first image elements are arranged in a first region of the microlens region. The first relief structures are designed so as to generate or provide structure-based colors and/or color effects.
Providing or generating second relief structures in the replication layer, wherein the second relief structures are assigned to a plurality of second image elements, and optionally providing or generating a partial lacquer layer, which is preferably assigned to a plurality of second image elements. The second image elements are arranged in a second region of the microlens region, wherein the second region is preferably separate from the first region, and in particular, the second region adjoins the first region.
Providing or generating a metal layer on the replication layer.
Demetallizing the metal layer using one or more of the second relief structures and optionally the partial lacquer layer as a mask, such that a partial metal layer is obtained. In the second region, a contour of the partial metal layer follows a contour of the second relief structures and forms a contour of the second image elements. Here, the partial metal layer is maintained over the predominant part of the full area or over the full area in the first region. Alternatively, the metal layer is completely removed in the first region. Alternatively, the metal layer is not provided in the first region. In particular, therefore, the metal layer is arranged in the first region such that the contour of a plurality of the first image elements is independent of the contour of the partial metal layer, which is obtained in particular after the demetallizing operation.

It is possible that the steps are carried out in the stated sequence or in some other sequence. In particular, it is possible that the step of providing or generating a microlens array in a microlens region takes place before or after the step of demetallizing the metal layer.

The multilayer body according to the invention is in particular a security element. The multilayer body according to the invention is preferably produced by means of the method according to the invention. The multilayer body according to the invention comprises:
A spacer layer, in particular as a carrier ply, having a first side and having a second side situated opposite the first side.
A microlens array in a microlens region, wherein the microlens array is arranged on the first side of the spacer layer. The microlens array may be formed over the full area or in parts.
A replication layer on the second side of the spacer layer.
First relief structures which are assigned to a plurality of first image elements which are arranged in a first region of the microlens region, wherein the first relief structures generate or provide structure-based colors and/or color effects.
Second relief structures, which are assigned to a plurality of second image elements, and optionally a partial lacquer layer, which is preferably assigned to a plurality of second image elements. The second image elements are arranged in a second region, which is preferably separate from the first region, of the microlens region, wherein the second region preferably adjoins the first region.
A partial metal layer applied to the replication layer, wherein, in the second region, a contour of the partial metal layer follows a contour of one or more relief structures of the second relief structures and forms a contour of the second image elements. Preferably, the contours of the partial metal layer are arranged in register with, preferably in perfect register and/or without a position tolerance relative to, the one or more relief structures of the second relief structures. Here, preferably mirror surfaces and/or in particular structures, preferably relief structures, having an aspect ratio of less than 0.25 are formed in particular in those second image elements which are provided with the partial metal layer. In particular, preferably relief structures having an aspect ratio of greater than 0.3 are formed in those second image elements which are not provided with the partial metal layer and/or in which the metal layer is removed during the demetallizing operation. In the first region, the partial metal layer is either not provided or is present over the predominant part of the full area or over the full area in the first region, in particular such that the contour of a plurality of the first image elements is independent of the contour of the partial metal layer.

The object is also achieved by a security document comprising the multilayer body, in particular the security element. Such a security document is for example a banknote or an identification document.

The multilayer body according to the invention is in particular produced by means of the described method according to the invention, such that the multilayer body may preferably have one or more of the features that can be obtained by means of the method, and/or the method has features of the multilayer body according to the invention.

By means of the present method for producing a multilayer body, and the multilayer body, it is achieved that regions having a particularly high resolution can be realized, wherein the production process can additionally be made particularly efficient.

In particular, owing to the high resolution, it is possible by means of the first relief structures to provide a greater density of items of image information, and thus to advantageously utilize these for regions with relatively complex movement effects depicted through the microlenses, whilst the second images can be perfectly in register with these and with one another. Furthermore, the second image elements can be highlighted with high contrast, and provided with a colored background, by means of a color layer which is situated behind the partial metal layer in particular as seen in a view directed through the microlenses.

For example, a perfect register between the first and the second region, and a corresponding interaction of their effects, can be achieved by virtue of the second relief structure, which is used as a mask for the demetallizing of the metal layer, also being present in certain regions in an adjoining region in the first relief structure.

In particular, it is possible that, preferably owing to the aforementioned demetallizing operation, the multilayer body, preferably the multilayer body that can be obtained by means of the method, exhibits a perfect register and/or an arrangement without a position tolerance between second relief structures and the partial metal layer arranged on the second relief structure and/or between the partial metal layer and the partial lacquer layer which is optionally arranged on the partial metal layer. Thus, in the first region, there may be first relief structures which are not constrained by the requirements on such a demetallizing operation, and which therefore provide, for example, relatively high-resolution optical effects with heterochromatic impressions. A high resolution is of major importance in particular in the case of microlens arrays for complex movement effects and/or magnification effects and/or 3D illusion effects. It is thus firstly possible to provide a very striking optical effect and thus also a security feature that is easy for a layperson to inspect. At the same time, it is possible to generate, in the first region, an optical effect which is particularly difficult for forgers to reproduce, and to achieve, in the second region, a perfectly in-register arrangement, which is also particularly difficult to reproduce, in particular with a colored background. In particular, the first relief structures may be designed such that they cannot be used as a mask during the demetallizing operation, such that a forger would rule out such a demetallizing operation or would have to invest particularly great effort in carrying out further method steps in order to create an exact reproduction. Forgers are thus forced, for example, to accept a demonstrably greater register deviation or a lower resolution. Protection against forgery is thus increased, and an improved optical impression of microlens effects is also achieved.

In particular, it has also been found that overetching or underetching of the metal layer can occur depending on various method parameters during the demetallizing operation, such as the duration of the etching operation. It is thus indeed possible to achieve a perfect register between the metal layer and the one or more second relief structures and/or the partial lacquer layer, and to thus achieve a particularly high level of protection against forgery. However, if a certain minimum area of the metal layer is undershot, overetching and underetching of the small image elements then become highly significant. It can therefore be particularly advantageous to use other production methods or structures, for example for color effects having relatively high resolutions, in certain regions. For this purpose, use may be made of the first relief structures, which are not constrained by the requirements on the secondary structures. As an additional advantage, substeps such as the generation of the metal layer and/or the removal of regions of the metal layer, or the printing of lacquer layers in parts or over a full area, may be carried out simultaneously and/or in one working step for both regions or effects. In particular in comparison with the separate production and bringing-together of a plurality of security elements and/or transfer plies which are each produced separately and for example assembled in one security document, it is thus possible for the outlay on production to additionally be greatly reduced.

Structure-based colors and/or color effects exhibit different defined colors and/or different defined contrasts, preferably in a direct reflection, in particular by means of light absorption in a metal layer on a corresponding relief structure, for example by plasmon excitation, or by means of refraction index differences on the corresponding relief structure in different regions, and/or exhibit different defined colors and/or different defined contrasts in different defined viewing situations, preferably even when disregarding other color layers that are optionally arranged in the multilayer body. The different viewing situations are in particular different viewing angles, which can be varied for example by tilting and/or rotating the multilayer body, preferably under constant illumination conditions. In the case of structure-based color effects, in order to achieve a color difference or a contrast difference, there is in particular no need for a color lacquer layer, colorants, pigments etc., though these may optionally be provided. In particular, the metal layer and/or an HRI layer assumes a form which follows the first and/or second relief structures, whereby a difference in refractive index in relation to the replication layer is realized. A movement pattern and/or a color shift effect of one or more motifs is preferably provided in the first region by means of the structure-based color effects, and can be brought about, in a view directed through the microlens array, by tilting and/or rotating the multilayer body.

The contour is to be understood in particular to mean one or more outer lines, preferably of a corresponding layer, ply or structure or of a partial structure, preferably in a view directed perpendicularly onto a plane spanned by the multilayer body.

A region is to be understood here in particular to mean a space which covers a defined area of the multilayer body or of a layer, foil or ply, the region having said area in a view directed perpendicularly onto one of the multilayer body or corresponding layer, foil or ply, wherein the space having said area extends through the multilayer body or the layer, foil or ply in this viewing direction.

The plane spanned by the multilayer body or a layer, foil or ply is in particular a plane which is spanned by the multilayer body or the layer, foil or ply when disregarding the layer thickness of the multilayer body or of a layer, foil or ply, that is to say preferably when disregarding that spatial direction, preferably in a Cartesian coordinate system, which has the smallest dimensions.

A view directed onto a front side is understood here preferably to mean a view in which the effects visible through the microlenses are observed. A view of a rear side is in particular a view directed onto a side of the multilayer body which is situated opposite the front side.

The term “register accuracy” or “in register” is to be understood to mean positional accuracy or an accurately positioned arrangement of two or more plies, elements, regions and/or layers relative to one another. Here, the register accuracy should lie within a predefined tolerance, and be as close as possible. At the same time, the register accuracy of a plurality of plies, elements, regions and/or layers with respect to one another is in particular an important feature for increasing process reliability and/or product quality as well as protection against forgery. The accurate positioning is achieved here in particular by means of register marks that are detectable by sensor means, preferably optically. These register marks may either be special separate plies, elements, regions and/or layers, or may themselves be part of the plies, elements, regions and/or layers to be positioned. It is advantageously possible to achieve a perfect register between two layers even without the use of register marks, by virtue of one of the layers being used as a reference, in particular as a mask for the processing, in particular the structuring, of the other layer, for example during the demetallizing operation in the method according to the invention.

It is possible that one or more image elements of the first image elements or of the second image elements are present outside the microlens region, wherein these image elements are not situated in the microlens region in particular owing to register tolerances, for example owing to the relative positioning of microlens array and the first relief structures or of microlens array and the second relief structures, and preferably constitute a small number of image elements.

Preferably in relation to the multilayer body and/or the spacer layer, the microlens region is in particular applied over the full area or over a partial area, preferably in a view directed perpendicularly onto a plane spanned by the multilayer body. It is possible that the microlens region is formed so as to cover the entire surface of the spacer layer or only parts thereof.

Preferably in relation to the multilayer body and/or the spacer layer, the replication layer is in particular applied over the full area or over a partial area, preferably in a view directed perpendicularly onto a plane spanned by the multilayer body. It is possible that the replication layer is formed so as to cover the entire surface of the spacer layer or only parts thereof.

Preferably in relation to the multilayer body and/or the spacer layer, the first relief structures are in particular molded into the replication layer over the full area or over a partial area, preferably in a view directed perpendicularly onto a plane spanned by the multilayer body.

The second region in particular adjoins the first region, preferably such that a spacing between the first and the second region is less than 1 mm, more preferably less than 0.8 mm and in particular less than 0.5 mm, in particular in a view directed perpendicularly onto a plane spanned by the multilayer body.

The partial metal layer is maintained over the predominant part of the full area in the first region or is present over the predominant part of the full area in the first region by virtue of in particular only partial regions of the metal layer being removed in the first region. These partial regions may preferably form small motifs and/or interruptions, for example in linear form, in the partial metal layer. The partial regions are in particular provided at least in certain regions with a contour which is independent of the contours of the first relief structures. In particular in a view directed perpendicularly onto a plane spanned by the multilayer body, the partial regions are preferably smaller than the first region provided with the partial metal layer, and preferably have at most 20% of the area of the first region provided with the partial metal layer.

An aspect ratio, or depth-to-width ratio, of a structure is to be understood in particular to mean the structure depth divided by the structure period or the structure depth divided by the average structure interval, wherein the average structure interval is preferably determined over at least 10 structure elements and more preferably at least 20 structure elements. The average structure interval is thus determined for example as the distance between the start of a first structure element and the start of an eleventh structure element, divided by 10.

Relief structures may be understood in particular to mean a single relief structure of the same type which is present in one or more image elements, or else relief structures of different types which are present in a plurality of image elements. In particular, it is for example possible for second relief structures of the same type to be present in the second region and/or present in particular only in regions without a partial metal layer, and/or for no second relief structures to be present in the second region with a partial metal layer.

Expressions such as “first”, “second” and “further” are used in particular for the purposes of distinction between different objects or methods or method steps. For example, a “second” or “further” object or a “second” or “further” method preferably does not necessarily imply the presence of a “first” object or a “first” method.

Further advantageous refinements of the invention are indicated in the dependent claims.

The first relief structures are in particular designed so as to generate or provide structure-based contrast differences and/or structure-based color differences within the first image elements and/or within one or more images which, preferably in the first region, are visible through the microlens array at one or more viewing angles. Here, the first relief structures preferably comprise one or more subwavelength gratings.

It is possible that, in particular in a view directed perpendicularly onto a plane spanned by the multilayer body, the first relief structures and/or second relief structures have at least one relief structure comprising a periodic variation of elevations and depressions in an x direction and/or in a y direction. Here, the elevations are in particular arranged in succession with a grating period Λ, wherein the minima of the depressions preferably define a base surface and have a relief depth t.

A contour of a relief structure, in particular in the first and/or second region, preferably of at least one relief structure of the second relief structures, is present in particular at the transition from a base surface to surrounding regions. Surrounding regions may for example be regions without a relief structure, and/or one or more other relief structures may be arranged in the surrounding regions. Preferably, said one or more other relief structures, in particular in the first and/or second region, preferably of the second relief structures, have an aspect ratio of less than 0.25. In particular in the first and/or second region, the relief structure having the contour may have an aspect ratio of greater than 0.3. If this relief structure having a contour and an aspect ratio of greater than 0.3 is arranged in the second region, the metal layer may for example be removed within the contour. These one or more other relief structures in the first and/or second region may also have a varying azimuth angle and/or a varying grating period.

The grating period A of the at least one first relief structure is preferably less than a wavelength of 500 nm, more preferably less than a wavelength of 400 nm, and/or less than wavelengths of light which is visible to the human eye. A contrast difference and/or color difference may for example be provided by virtue of the first relief structures being made up of a plurality of such relief structures, which for example differ in terms of their grating period and/or their grating depth and/or their profile shape. In particular, the further first image elements thus generate a different color and/or a different contrast, preferably when viewed at one or more defined viewing angles.

Mirror surfaces are to be understood in particular to mean smooth and planar mirror surfaces. A smooth and planar mirror surface is in particular to be understood to mean that, at the locations of the mirror surface, the replication layer has a preferably low surface roughness, without additionally being provided with depressions or elevations, and is optionally produced by being pressed against a smooth die, in particular before a further layer is applied to said surface. A mirror surface is preferably provided with the partial metal layer.

It is also possible for at least one relief structure of the second relief structures to be assigned to the second image elements, in particular first image element regions of the second image elements, and to have an aspect ratio of greater than 0.3, preferably greater than 0.5. Preferably, a contour of the partial metal layer, in particular after the demetallizing operation, follows a contour of said at least one second relief structure.

Image element regions may in particular constitute one coherent region and/or one or more separate regions.

An aspect ratio of greater than 0.3 can advantageously be easily utilized during an exposure in order to use the second relief structures as a mask during the demetallizing operation, in particular by virtue of one or more photoresist lacquers being more intensely exposed through the metal layer in regions having an aspect ratio of greater than 0.3 than in other regions. The at least one relief structure of the second relief structures having this aspect ratio of greater than 0.3 comprises or is in particular at least a diffractive relief structure. The width of the structure refers here in particular to the grating period A or, in the case of random structures, to the average spacing of maxima of elevations or depressions. In the case of random structures, the depth is in particular the average depth of the relief depths t.

It is also possible that, in the second region, further image element regions of the second image elements are provided, which have or are assigned one or more of the following structures: mirror surfaces, statically and/or isotropically matte surfaces, optically variable structures, in particular diffractive structures, preferably having an aspect ratio of less than 0.25. These further image element regions of the second image elements are preferably covered by the partial metal layer, wherein, in particular, first image element regions of the second image elements are not covered by the partial metal layer, and/or the metal layer is removed in the first image element regions of the second image elements during the demetallizing operation.

One or more of the first relief structures may also be designed as a linear grating which has a sequence of elevations and depressions in one direction. The linear gratings may also be constructed from straight or curved lines, in particular serpentine lines, preferably so-called “snake gratings”. The lines are preferably formed by the elevations and/or depressions in particular in a view directed perpendicularly onto a plane spanned by the multilayer body. It is also possible for one or more of the first relief structures to be formed as a crossed grating or hexagonal grating or circular grating, which has a sequence of elevations and depressions in two directions. A pseudorandom grating structure is also possible. In the case of a crossed grating, the grating period A of the sequence of elevations and depressions is preferably selected, for both directions, to be in the range of a subwavelength grating. Here, in the case of crossed gratings, the period may in particular be equal in both directions. The period may however also differ. This applies analogously to hexagonal gratings and circular gratings. Tests have also shown that the design of the first relief structures as a crossed grating or as a hexagonal grating is particularly advantageous, in particular because more pronounced color impressions, in particular greater degrees of color saturation, are obtained with these gratings.

The relief depth t of a subwavelength grating is preferably selected to be between 50 nm and 400 mm, in particular between 80 nm and 350 nm, and particularly preferably between 100 nm and 300 nm. It has also been found that asymmetrical profile shapes of the subwavelength gratings can be advantageous, in particular because greater degrees of color saturation can hereby be achieved.

The metal layer should preferably be formed with a layer thickness d of between 10 nm and 100 nm, preferably between 15 nm to 80 nm and more preferably between 20 nm to 50 nm, if the multilayer body is designed to be observed under vertical illumination, in particular to be observed in a view directed onto at least the first and/or second image elements through the microlens array.

A view through the microlens array refers in particular to a view in the case of which the viewer is situated on the side of the microlens array and, for example, sees the first and second image elements through the microlenses.

As metals for generating colors and color effects by absorption on the basis of such subwavelength gratings, one or more of the following are preferably suitable: aluminum, silver, copper, gold or an alloy of the aforementioned metals.

The described effects can in particular be achieved with just one metal layer or partial metal layer, because the core effect is not based on thin-film interference.

The first and/or second image elements preferably form an item of image information. It is possible that the first image elements and the second image elements are assigned to a plurality of image element groups. The image element groups are preferably arranged as an array, wherein, in particular, an image element group has a plurality of first and/or second image elements, preferably in the form of a microimage, and thus, preferably in a view of the multilayer body directed onto the image elements through the microlens array, a defined image can be seen at each viewing angle of one or more defined viewing angles. The image points of each image are formed in particular only by those image elements of the image element groups which are visible through the microlenses of the microlens array.

It is possible that, at the one or more defined viewing angles, a defined image which is visible through the microlens array is created, which image differs from the microimages of the image element groups, and in particular also differs from larger-scaled microimages of the image element groups. It is also possible that the first region and/or second region are made up of a plurality of, in particular separate, subregions. It is also conceivable that an image element group has both first image elements and second image elements.

It is possible that the first image elements and/or the second image elements constitute pixels. In particular, each image element has a defined optical effect.

It is possible that the first region comprises or consists of a high-resolution microimage region and/or the second region comprises or consists of a low-resolution region. A smallest image element of the low-resolution microimage region preferably has a minimum width which is greater than a minimum width of a smallest image element of the high-resolution microimage region, preferably in a view directed perpendicularly onto a plane spanned by the multilayer body. A minimum width is to be understood in particular to mean a minimum spacing between two opposite outer lines of a contour.

Preferably, one or more second image elements comprise, in an x direction and in a y direction, one of the following numbers of grating periods of the second relief structure: at least three, three, at least five, five.

It is possible that the first relief structures, in particular the at least one relief structure of the first relief structures, and/or the first image elements, have a minimum width, in particular a minimum spacing between two opposite outer lines of the contour, of at least 1.5 μm, preferably in a view directed perpendicularly onto a plane spanned by the multilayer body.

It is thus advantageously possible that first relief structures, in particular the at least one first relief structure, in the form of subwavelength gratings having grating periods of less than 500 nm, preferably less than 400 nm, can still act as optically active gratings, in particular also of stand-alone first image elements. It is thus possible, for example, to achieve a particularly high resolution of the first image elements in the first region.

The first relief structures, in particular the at least one relief structure of the first relief structures, and/or the first image elements, preferably have, in particular at least in certain regions, a minimum width, in particular a minimum spacing between two opposite outer lines of the contour, of less than 2.5 μm. It is alternatively or additionally also possible that the second relief structures, in particular the at least one relief structure of the second relief structures, and/or the second image elements, have a minimum width, in particular a minimum spacing between two opposite outer lines of the contour, of at least 2.5 μm. In particular, preferably in the second region, the partial metal layer has a minimum width, in particular minimum spacing between two opposite outer lines of the contour, of at least 2.5 μm. With a minimum width of 2.5 μm, it is achieved in particular that in-register demetallization can be carried out in the second region, advantageously in such a way that any underetching or overetching which occurs does not have too great an impact. At the same time, to achieve an even higher resolution, the resolution in the first region can be configured independently of the contour of the partial metal layer and independently of the nature of the demetallization in the second region. Preferably, one or more, preferably stand-alone, second image elements which have the partial metal layer have a minimum width of 2.5 μm, in particular in a view directed perpendicularly onto a plane spanned by the multilayer body.

An item of image information that changes color when tilted can in particular be achieved not only by providing a suitable background color behind microlenses but for example also by means of suitable metallized structures such as the partial metal layer in the first region on the first relief structures. Preferably, the first region is provided, in parts, in particular in one or more first image element regions of the first image elements, with structures which appear colored in a direct reflection, and is provided, in parts, in particular in one or more further image element regions of the first image elements, with mirror surfaces, in particular mirror surfaces which appear silver-colored. It is thus possible, by means of the microlens array, to achieve a color change of moving motifs or design elements, in particular motifs or design elements which move virtually and/or as seen by the human eye, wherein the movement preferably arises or is brought about when the multilayer body is tilted and/or rotated.

The term “motifs” or “in the form of a motif” is to be understood for example to mean one or more shapes of geometrical form, guilloche, endless pattern, image, symbol, logo, emblem, portrait, alphanumeric character, QR code, barcode.

The at least one first relief structure is in particular assigned to one or more first image element regions of the first image elements, wherein, preferably, one or more further image element regions of the first image elements have a different structure than the at least one first structure, for example a different relief structure or a mirror surface.

It is in particular possible that, in the first region and/or in the one or more first subregions of the first region, the first image elements are formed at least by the partial metal layer arranged on the first relief structures, and the first relief structures, in particular the at least one relief structure of the first relief structures, comprise a first subwavelength grating, wherein the first subwavelength grating is assigned to one or more first image element regions of the first image elements, and wherein, in particular, the first relief structures comprise a second subwavelength grating which differs from the first subwavelength grating, wherein the second subwavelength grating is assigned to one or more further image element regions of the first image elements, and/or wherein one or more further image element regions of the first image elements comprise mirror surfaces.

Here, the subwavelength grating may in particular generate a golden or a red or a dark or black color in the metal layer as seen in a normal view. A normal view is preferably to be understood to mean a view directed perpendicularly onto a plane spanned by the multilayer body.

The first image element regions of the first image elements form for example one or more motifs which are visible through the microlenses, wherein the further image element regions of the first image elements form a background which is visible through the microlenses, and/or logically supplement the motifs. It is also possible that the further image element regions of the first image elements form for example one or more motifs which are visible through the microlenses, wherein the first image element regions form a background which is visible through the microlenses, and/or logically supplement the motifs.

The first subwavelength grating preferably differs at least in terms of its grating period and/or its azimuth angle from the second subwavelength grating.

It is possible that the first image elements comprise first image element regions and further image element regions, and the second image elements comprise first image element regions and further image element regions, wherein, in particular, the first relief structures of the first image element regions of the first image elements are of identical design to the second relief structures of the first image element regions of the second image elements, and/or the structures or first relief structures of the further image element regions of the first image elements are of identical design to the structures or second relief structures of the further image element regions of the second image elements.

Preferably, for the first relief structures, in particular the at least one first relief structure, a structure is used which generates or provides a color shift effect, in particular when the multilayer body is tilted, preferably tilted forward and/or backward. In particular, during the tilting movement, the color impression changes correspondingly. In a tilted view, the first image elements having the at least one first relief structure change in relation to a first view, which is for example directed perpendicularly onto a plane spanned by the multilayer body, preferably change from a first color to a second color, for example from a golden color to magenta. By contrast, in a region having further first image element regions, the image elements may also, in a first view and in the tilted view, appear in a third color, for example in a silver color.

The structure-based color effect of the first relief structures may optionally also be supplemented by a colored background, in particular by means of one or more color lacquer layers. It is hereby possible in particular to form a color gradient, which preferably covers the full area of the first and second regions and for example transitions from a first hue to one or more other hues, for example from blue or violet to cyan. In particular, it is possible here for mirror surfaces having a different hue to be provided, for example by means of a green color lacquer layer. It is thus possible, for example, to achieve an improved depth effect of the optical effects.

In particular for an angle of incidence in the range from 0° to 30°, in particular so-called golden mirror structures, in particular for generating a golden color impression, or the first image elements with the first subwavelength gratings, exhibit reflection of the incident light in at least 75% of the wavelength range from 400 nm to 500 nm which is lower by at least 10% in relation to the reflection in at least 75% of the wavelength range from 525 nm to 700 nm. In particular so-called golden mirror structures, or the first image elements with the first subwavelength gratings, preferably exhibit reflection of the incident light in at least 70% of the wavelength range from 400 nm to 500 nm which is lower by at least 15% in relation to the reflection in at least 70% of the wavelength range from 525 nm to 700 nm. In particular so-called golden mirror structures, or the first image elements with the first subwavelength gratings, more preferably exhibit reflection of the incident light in at least 90% of the wavelength range from 400 nm to 500 nm which is lower by at least 15% in relation to the reflection in at least 90% of the wavelength range from 525 nm to 700 nm. In particular so-called golden mirror structures, or the first image elements with the first subwavelength gratings, even more preferably exhibit reflection of the incident light in at least 90% of the wavelength range from 400 nm to 500 nm which is lower by at least 20% in relation to the reflection in at least 90% of the wavelength range from 525 nm to 700 nm.

The above reflection spectra are exhibited in particular by a so-called golden mirror structure. Preferably, the at least one relief structure of the first relief structures and/or the first subwavelength grating is formed as a so-called golden mirror structure, and the second subwavelength grating is formed as a so-called black mirror structure. It is also possible that the at least one relief structure of the first relief structures, in particular the first subwavelength grating, comprises a golden mirror structure and/or black mirror structure, in particular for generating a very dark to black color impression, wherein, in particular, the further image element regions of the first image elements comprise mirror surfaces. For example, it is thus possible, in particular in the first region, for a motif which is visible through the microlenses by means of the mirror surfaces or further image element regions of the first image elements to be provided with structure-based color effects which are visible through the first image element regions of the first image elements.

Suitable structures for golden mirror structures are in particular subwavelength gratings having a period P which is preferably selected to be less than a wavelength of visible light. In particular, visible light has wavelengths in the range between 400 nm and 700 nm. Such grating structures are referred to as subwavelength gratings. The grating periods typically lie in the range from 150 nm to 500 nm, preferably between 200 nm and 400 nm, and in particular between 200 nm and 350 nm. It has been found that, by adjusting the period P of the first relief structure, the color that the human viewer sees in the first region in a direct reflection and/or transmission is changed, and thus the hue of the color impression or the color effect that is seen in a direct reflection or transmission at different angles of incidence and angles of reflection can be changed by changing the period P of the relief structure in the aforementioned regions.

When the multilayer body is tilted, it is preferably the case that image regions which are formed by the first image elements with first relief structures, in particular in the form of a golden mirror structure, and which are visible through the microlens array change from a first color impression, preferably from a golden color impression, to a second color impression, preferably a magenta-colored color impression. Furthermore, during the tilting movement, a mixture of the first and the second color impression may be present between the first and the second color impression, in particular with subregions having the first color impression and subregions having the second color impression. Advantageously, such a color change of virtually moving motifs or design elements firstly constitutes an easily communicable security feature and can secondly intensify a standing-out effect and in particular depth illusions.

Image elements having a black mirror structure preferably exhibit, in a direct reflection, a reflection capability of less than 40%, and more preferably less than 30%, for incident light in the wavelength range from 400 nm to 700 nm.

One or more first and/or second image elements having a black mirror structure are in particular designed so as to preferably exhibit, in a direct reflection over a defined angle, in particular a relatively broad tilt angle range from in particular at least 0° to 30° with respect to the normal to the plane spanned by the multilayer body, a red or a brown or a dark color impression, in particular a black color impression, in a direct reflection or in transmission.

In particular, a black mirror structure which has at least one first relief structure and/or at least one second relief structure has a grating period or grating periods of less than 500 nm and greater than 300 nm and/or a relief depth t of greater than 150 nm. In order that a relief structure, preferably a black mirror structure and/or a golden mirror structure, is preferably optically effective, an adequate refractive index difference is preferably established on the relief structure. In particular, at least the partial metal layer and/or a preferably transparent HRI layer is present or provided in the image elements with relief structure, in particular black mirror structure and/or golden mirror structure, or so as to overlap same, such that said layer can preferably provide the corresponding refractive index difference. The partial metal layer is preferably opaque or semitransparent.

Transparent refers in particular to a transmission of at least 70%, in particular averaged over the wavelength range from 380 nm to 780 nm. Semitransparent refers in particular to a transmission in a range from 10% to 70%, in particular averaged over the wavelength range from 380 nm to 780 nm. Opaque refers in particular to a transmission of at most 10%, in particular averaged over the wavelength range from 380 nm to 780 nm.

For example, the advantage is achieved that, in the first region, one or more first image elements having a dark color effect can, by means of the black mirror structure, be made smaller than is possible with conventional printing processes or with the method for demetallization in the second region.

It is possible that, in the first region, mirror surfaces, in particular smooth and planar mirror surfaces, are provided in addition to the black mirror structure, wherein the mirror surfaces are preferably assigned to further image element regions of the first image elements.

It is also possible that, in the second region, mirror surfaces, in particular smooth and planar mirror surfaces, are provided in addition to the second relief structures, in particular the at least one second relief structure, wherein the mirror surfaces are preferably assigned to further second image element regions of the second image elements.

It is preferably possible that the first relief structures are designed such that a motif differs in terms of color from a background when viewed in a defined viewing situation, in particular in a view directed perpendicularly onto a plane spanned by the multilayer body, and, when the multilayer body is tilted, preferably to the first order of diffraction of one of the first relief structures, in particular of the at least one first relief structure, the motif preferably changes from a positive to a negative appearance or from a negative to a positive appearance, in particular by virtue of the motif becoming brighter and the background becoming darker, or the motif becoming darker and the background becoming brighter.

It is possible that, for this purpose, the first relief structures, in particular the at least one first relief structure, comprises one or more first subwavelength gratings, in particular black mirror or golden mirror structures, which are assigned to one or more first image element regions of the first image elements, and comprises one or more mirror surfaces, which are assigned to one or more further image element regions of the first image elements. It is also possible that, for this purpose, the first relief structure comprises one or more first subwavelength gratings, in particular black mirror structures or golden mirror structures, which are assigned to one or more first image element regions of the first image elements, and comprises one or more second subwavelength gratings, in particular black mirror structures or golden mirror structures, which are assigned to one or more further image element regions of the first image elements.

If the two different subwavelength gratings have different grating periods, then it is the case in particular that the first order of diffraction of the two subwavelength gratings lights up at different angles in each case, in particular at slightly different angles in each case. It is thus possible, for example, to achieve the impression of an inversion of the colors of the image region which is generated by the first region and which in particular is visible through the microlens array, said impression being created in particular as the multilayer body is tilted, preferably tilted to a high degree, proceeding from a normal view. Here, a background provided by further image element regions of the first image elements preferably changes from bright to dark or from dark to bright.

In particular, it is possible that a brighter lighting-up effect is generated by the one or more subwavelength gratings, preferably in the form of golden mirror structures or black mirror structures, during a tilting movement, preferably to a high degree, in particular at a viewing angle in a range of greater than 50° as measured from a normal to a plane spanned by the multilayer body, and/or in the viewing situation for illumination and a viewing angle of the first order of diffraction. Here, it is for example possible for the golden mirror structures to be present in first image element regions of the first image elements and for the black mirror structures to be present in a background of the first image elements, said background being formed by further image elements, or vice versa, that is to say, in particular, it is for example possible for the black mirror structures to be present in first image element regions of the first image elements and for the golden mirror structures to be present in a background of the first image elements, said background being formed by further image element regions. In particular, said regions advantageously light up brightly when tilted to a high degree, such that the condition for illumination and viewing angle for the first order of diffraction is satisfied, whereas the regions having the subwavelength gratings appear colored (for example golden mirror) or dark (for example black mirror) in a normal view. Lighting up more brightly is to be understood in particular to mean a greater light intensity in relation to other viewing situations under the same illumination.

This typically occurs at a tilt angle of greater than 50°. For example, if first image element regions of the first and/or second image elements are used to generate a motif or an item of image information and further image element regions of the first and/or second image elements are used to generate a background, and in this case the first image element regions which generate the motifs are formed from a mirror surface, and the background, which is formed in particular by further image element regions, is formed from a subwavelength grating with a dark appearance, in particular a black mirror structure, then in a normal view the viewer sees in particular bright motifs or icons, or a bright item of image information, on a dark background. During a tilting movement, preferably to a high degree, the item of image information inverts from a positive appearance to a negative appearance, which can advantageously constitute a further forgery-proof feature of this microlens feature. The advantageous inversion can also be achieved by virtue of the motifs or item of image information and the background being formed from subwavelength gratings, as long as the two subwavelength gratings, for example golden mirror structures and black mirror structures, have different grating periods and/or different azimuth angles.

It is possible that one or more thin-film effect pigments, in particular OVI (optically variable ink) and/or OVMI (optically variable magnetic ink), are integrated, and/or one or more thin-film effect layers having these thin-film pigments are arranged or applied, on that side of the metal layer which faces away from the replication layer, in particular on the rear side of the metal layer as seen in a view through the microlens array. It is hereby possible, in particular, to achieve by means of the pigments a thin-film effect which is visible only from a rear side, whereas the structure-based color effects are visible through the microlens array in the first region from a front side. It is also possible for the thin-film effect pigments or thin-film effect layers, in particular with OVI and/or OVMI, to be printed onto the spacer layer, in particular as a carrier ply in the form of a polymer substrate. For this purpose, printing inks may be applied by means of one or more of the following methods: screen printing, gravure printing, flexographic printing. OVI pigments are typically constructed in multi-ply form and symmetrically from absorber layer, dielectric layer, reflection layer, dielectric layer, absorber layer, in particular in the stated sequence: These layers they each have one or more of the following materials:
Absorber layer: Cr, Al, Fe.
Dielectric layer: MgF₂, Fe₂O₃, Cr₂O₃, MgO, SiO₂.
Reflection layer: Al, Fe, Ni, Cr, Zn.

An example of such an OVI pigment is a multi-ply system consisting of:

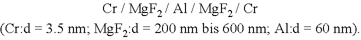

An OVMI pigment is in particular constructed in the same way as an OVI pigment, with the difference that the reflection layer is additionally magnetic. Nickel, for example, may be used as metal for this purpose. An example for the structure of an OVMI pigment is as follows:

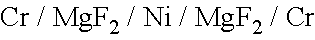

Furthermore, such OVI pigments are preferably coated with anionic surfactants, preferably with organic esters and fluorinated organic esters of phosphoric acid. Manufacturers of such colors are for example SICPA, Gleitsmann Security Inks, Sun Chemical, Printcolor Screen AG. The printing inks may in particular be in the form of aqueous, solvent-containing or UV formulations. For example, the following color changes may be generated: red to green, green to blue, gold to green

It is possible that the first relief structures in the first region have at least one relief structure having a linear subwavelength grating. In particular, it is possible that the linear subwavelength grating is designed such that, for the demetallizing of the metal layer, the metal layer on the linear subwavelength grating is more permeable to radiation, in particular UV radiation, of an exposure than one or more of the second relief structures, in particular than the at least one second relief structure, such that only the one or more relief structures in the second region, in particular the at least one second relief structure, is used as a mask, wherein, preferably, the metal layer and optionally a photoresist lacquer layer applied prior to the demetallizing operation is completely removed in the first region.

It is possible that the linear subwavelength grating has a first diffraction grating and at least one second diffraction grating, each having a grating period from the range from 100 nm to 500 nm, preferably from 180 nm to 420 nm, wherein the first diffraction grating and the second diffraction grating are designed such that, at a predetermined rotational angle, defined with respect to a rotation about a normal to a plane spanned by the multilayer body, and at a specified illumination angle, a first color is generated by the first diffraction grating and a second color that differs from the first color is generated by the second diffraction grating. Here, the linear subwavelength gratings are preferably provided with a high-refractive-index layer, for example consisting of TiO₂ or ZnS.

Such linear subwavelength gratings are also referred to as RICS (Rotation Induced Color Shift) structures.

A normal to a surface of the multilayer body is in this case in particular a normal to a plane spanned by the multilayer body.

It is possible that a preferably transparent HRI layer is provided over part of the area, in particular in the form of a motif, or over the full area at least in the first region, in the first region and in the second region, or over the full area in the multilayer body, in particular in a view directed perpendicularly onto a plane spanned by the multilayer body.

HRI stands for “high refractive index”. An HRI layer is in particular a high-refractive-index layer having a refractive index of at least 1.5. In particular, an HRI layer comprises or consists of TiO₂, ZrO₂ and/or ZnS. An HRI layer is preferably applied by vapor deposition.

One or more relief structures of the second relief structures and/or one or more of the second image elements preferably have grating structures, in particular subwavelength gratings having an aspect ratio of greater than 0.3, preferably greater than 0.5.

Such structures are in particular used as a mask during the demetallizing operation, or are designed to be suitable for this purpose.

It is possible that first image element regions and further image element regions of the second image elements are present in the second region. It is possible that further image element regions of the second image elements, in which the partial metal layer is not present and/or in which the metal layer is removed during the demetallizing operation, are present in the second region. It is in particular also possible that first or further image element regions of the second image elements are provided, in which the multilayer body is of transparent or semitransparent form, in particular by virtue of no partial metal layer being provided in corresponding regions having the further image elements of the second image elements.

It is possible that the second relief structure has a grating which is at least also present in the first region in a first subregion which adjoins the second region having the second relief structure and which has the first relief structure, and, in a second subregion of the first region, the first relief structures provide further image element regions of the first image elements, which further image element regions, when they are viewed through the microlenses, generate at least one common closed motif together with the further image element regions of the second image elements. Since the second relief structures serve as a mask during the demetallizing operation, a perfect register relative to the first region can be generated or provided. The grating which is present in the first and second relief structures is preferably a subwavelength grating, in particular a black mirror structure and/or golden mirror structure.

It is in particular also possible here that, in the second region, the second relief structures, preferably mirror surfaces and/or in particular structures, preferably relief structures, having an aspect ratio of less than 0.25 are formed in particular in those second image elements which are provided with the partial metal layer, and that, in the first region, the first relief structure has one or more of the following structures: subwavelength grating, mirror surface, static matte structures, diffractive color gratings, preferably such that, when the multilayer body is tilted, moving motifs formed by first and second image elements are visible through the microlens array, wherein the first region preferably directly adjoins the second region, wherein, more preferably, at at least one viewing angle, at least one motif is formed both from first image elements and from second image elements, in particular both from first image elements and from further image element regions of the second image elements. It preferably possible here for one or more color lacquer layers to be arranged in the second region, preferably over the full area and/or only so as to overlap the second relief structure.

Color gratings are in particular linear or crossed diffraction gratings having a grating period of 700 nm and 1500 nm.

It is in particular possible that the first relief structure and the first image elements and also the second relief structure and the second image elements are designed such that, when they are viewed through the microlens array and when the multilayer body is tilted from a first predefined viewing angle to a second predefined viewing angle, at least one motif moves from the first region into the second region, and/or at least one motif moves and in so doing overlaps both the first region and the second region.

It is thus possible in particular to provide an intuitively easily understandable optical effect, which is however difficult to forge.

It is also conceivable for further subregions having further optically variable effects to be provided in the multilayer body, and for these to preferably be arranged in register, in particular in perfect register, with the first and/or second region.

It is also possible, in particular in the replication layer and/or in the plane of the first and second relief structures, for third relief structures to be formed, in particular in the form of a microstructure, and subsequently preferably provided with the partial metal layer. The third relief structures are preferably applied in a third region, wherein the third region preferably overlaps the microlens region in certain regions and/or is arranged outside the microlens region. It is thus possible, for example, for a further optically variable effect to be provided within and/or outside the microlens region, which effect advantageously exhibits a perfect register between partial metal layer and third relief structures. For this purpose, it is advantageous for at least one relief structure of the third relief structures to have an aspect ratio of greater than 0.3, preferably greater than 0.5. Preferably, a contour of the partial metal layer after the demetallizing operation follows a contour of said at least one third relief structure.

It is also possible that one or more further optical effects and/or layers are formed in the multilayer body in register with the microlens region, in particular at least partially outside the microlens region, preferably so as to partially overlap the microlens region and/or be adjacent to the microlens region, more preferably with a spacing of at most 1 mm, said further optical effects and/or layers in particular being selected individually or in combination and/or in a superposed configuration from one or more of the following effects and/or layers: diffractive relief structure, Fresnel lens, Fresnel-like freeform surface, matte structures.

Advantageously, at least one of the third relief structures, in particular selected from one or more of those mentioned above, may be formed into the replication layer in the same working step and/or simultaneously with the first and/or second relief structure.

Since the optically variable effects which, owing to the third relief structure with the partial metal layer, are arranged in the item of image information in perfect register with the optically variable microlens effects, it is advantageously possible to generate easily explicable and particularly forgery-proof security features. For example, it is possible to achieve that subregions of a security feature which comprises in particular the third relief structure and preferably also the partial metal layer light up at different tilt angles and make the overall impression of the multilayer body even more self-explanatory and thus forgery-proof. At the same time, method steps can be saved since, for example, it is possible to generate a partial metal layer for a wide variety of optical effects by means of just one demetallizing step. It is also possible for the microlens array and/or the microlens region to overlap parts or the full area of the third relief structure.

Microlenses situated over the third relief structures, which are for example diffractive structures, lessen the effect of the third relief structures, for example the diffractive effect, inter alia by scattering the light. For this reason in particular, it is preferable that such structure-based effects which are arranged in the microlens region are planar. Here, planar preferably refers to regions, which are coherent as seen by the human eye, of at least 1 mm², more preferably at least 2 mm², particularly preferably at least 4 mm², and more preferably at least 9 mm², in particular in a view directed perpendicularly onto a plane spanned by the multilayer body. The area is preferably measured without a microlens array.

It is possible that the first region has one or more first subregions, in which an optically variable effect of a first motif can be seen through the microlens array through an associated first subregion, and/or the second region has one or more second subregions, wherein an optically variable effect of a second motif can be seen through the microlens array through an associated second subregion, wherein, preferably, the first and the second motif are motifs which differ from one another.

In at least one of the second subregions, an optically variable effect is brought about preferably only by means of the microlens array, and/or the second image elements in at least one of the second subregions have a static optical effect, in particular when disregarding the microlens effect.

It is possible that, in a mirror region in the second region and/or in the one or more second subregions, one or more second image elements comprising the partial metal layer and mirror surfaces are provided, that, in a structure region in the second region and/or in the one or more second subregions, one or more second image elements comprising the partial metal layer and the second relief structures, in particular in the form of microstructures, for example diffraction gratings and/or achromatic blaze gratings and/or a matte structure, preferably a static and/or isotropic matte structure, are provided, and that, in the first region, one or more first image elements having a metal layer and having a structure-based color effect are provided, preferably one or more first image elements, in particular first image element regions of the first image elements, are provided by means of subwavelength gratings and one or more further first image elements, in particular further image element regions of the first image elements, are provided by means of mirror surfaces, or one or more first image elements, in particular first image element regions of the first image elements, are provided by means of subwavelength gratings and one or more further first image elements, in particular further image element regions of the first image elements, are provided by means of other subwavelength gratings.

It is possible that, in particular in a view directed perpendicularly onto a plane spanned by the multilayer body, a total area is formed by the mirror region, by the structure region in the second region and by the first region, wherein the ratio of the area of the mirror region to the total area, the ratio of the area of the structure region in the second region to the total area, and the ratio of the area of the first region to the total area, differ from one another by less than 20%, preferably less than 10%. The difference is preferably determined by the absolute value of the difference between two ratios. Here, the first region is in particular arranged only in regions having first image elements.

Preferably, an area of respectively covered regions, in particular in a view directed perpendicularly onto a plane spanned by the multilayer body, is determined by one or more of the following variants V1 to V3, which in particular each provide different microlens effects.
V1=second image elements, in particular further image element regions of the second image elements, with partial metal layer and with mirror surface,
V2=second image elements, in particular first image element regions of the first image elements, with partial metal layer and with second relief structures, in particular microstructures, for example diffraction gratings and/or achromatic blaze gratings and/or a matte structure, preferably static and/or isotropic matte structure,
V3=first image elements, in particular first image element regions and further image element regions of the first image elements, that is to say preferably together with a background of the first image elements, with metal layer and with structure-based color effect, for example subwavelength gratings one or more first image element regions of the first image elements and mirror surface one or more further image element regions of the first image elements or subwavelength gratings one or more first image element regions of the first image elements and other subwavelength gratings one or more further image element regions of the first image elements.

The proportions of the different variants V1 to V3 are preferably approximately equal. The difference in the proportions of all variants relative to one another is preferably less than 20% and particularly preferably less than 10%. The difference is preferably determined by the absolute value of the difference between two ratios in relation to the total area of V1 to V3; for example the difference between V1 and V2=|V1/(V1+V2+V3)−V2/(V1+V2+V3)|.

A forger must therefore, for example, imitate microlens effects having very different appearances in combination with a security feature, which constitutes a major hurdle.

It is possible that the microlens array comprises different partial microlens arrays by virtue of these differing in particular in terms of their grating width, orientation, lens shape, lens spacing, lens height, focal length. It is possible that one or more partial microlens arrays are each arranged in register with one of the following regions or at least one other layer arranged therein: first region, one or more first subregions, second region, one or more second subregions. It is thus possible for the first and second region and/or first and second subregions to be arranged in register with one another.

It is possible that the partial lacquer layer is a resist lacquer, in particular an etching resist, and is applied at least partially in the first region and optionally over the full area in the second region, wherein, during the demetallizing of the metal layer using a solvent, in particular etching agent, the resist lacquer, in particular etching resist, protects the metal layer such that a contour of the partial metal layer follows a contour of the partial lacquer layer, in particular in perfect register and/or without position tolerances.

It is possible that the partial lacquer layer is applied preferably over the full area in the first region prior to the demetallizing operation, in particular such that the metal layer is preferably maintained over the full area in the first region during the demetallizing operation.

It is possible that, for the demetallizing operation, a photoresist lacquer layer is applied, preferably directly or indirectly, to the replication layer, in particular to the replication layer having the metal layer, and is preferably exposed, preferably exposed to UV radiation, such that the photoresist lacquer layer either can be removed in regions having one or more second relief structures, in particular the at least one second relief structure, in the second region, or can be removed outside the regions having second relief structures, in particular having the at least one second relief structure, in the second region, wherein, in particular, the photoresist lacquer layer is subsequently removed, so as to obtain the partial lacquer layer or a second partial lacquer layer, and preferably protects the metal layer during the demetallizing operation such that a contour of the partial metal layer follows a contour of the partial lacquer layer and/or of the second partial lacquer layer, in particular in perfect register and/or without position tolerances.

Here, in particular, structure-based effects of the second relief structures, preferably of the at least one second relief structure, are utilized, because these in combination with a metal layer over a full area make it possible to achieve different levels of transmission of light of a particular wavelength, in particular of wavelengths in a range from 200 nm to 400 nm, such that demetallization similar to a relief structure can be achieved by means of a photostructurable lacquer system.

It is possible that the photoresist lacquer layer is monochromatic or polychromatic and/or has a color gradient. The photoresist lacquer layer may in particular be transparent or opaque. The photoresist lacquer layer is preferably applied by means of one or more of the following methods: screen printing, offset printing, flexographic printing or gravure printing. In particular, the photoresist lacquer layer is, preferably at least in the second region, firstly applied over the full area and subsequently structured.

It is possible that, after the photoresist lacquer layer has been exposed, the multilayer body is brought into contact with a solvent, in particular etching agent, and the photoresist lacquer layer and in particular the metal layer are partially removed by the solvent, in particular etching agent, preferably either in more intensely exposed regions or in less intensely exposed regions of the photoresist lacquer layer. It is also possible to combine the demetallization by means of a photoresist lacquer layer and the application of the partial lacquer layer as an etching resist. It is also possible that the second partial lacquer layer is removed after the demetallizing operation. It is also possible that the partial lacquer layer remains in the produced multilayer body.

The partial and/or second partial lacquer layer is preferably monochromatic or polychromatic and/or preferably has a color gradient. The partial lacquer layer and/or the second partial lacquer layer may in particular be transparent or opaque. The partial lacquer layer is preferably applied by means of one or more of the following methods: screen printing, offset printing, flexographic printing, digital printing, in particular inkjet printing or gravure printing.

It is advantageously possible that, in the produced multilayer body, the partial lacquer layer and/or the second partial lacquer layer is arranged in perfect register and/or without position tolerances relative to the second relief structure and preferably relative to and/or in the first region.

It is possible that the metal layer in the first region is partially demetallized without using the second relief structure, in particular the at least one relief structure of the second relief structure, as a mask, and/or that, after the demetallizing operation, the partial metal layer in the first region coherently overlaps regions having a relief structure and adjoining regions without a relief structure or having a different relief structure of the first relief structures, and/or is protected during the demetallizing operation by a lacquer layer arranged preferably over the full area in the first region, in particular by the partial lacquer layer and/or the further partial lacquer layer.

It is possible that a mask layer is provided in the first region, in particular between the metal layer and the microlens array, preferably over the full area or in parts, preferably in the form of a motif, wherein, in particular, the mask layer is preferably used as a mask during the demetallizing of the metal layer in the first region, in particular such that, during the demetallizing operation, the partial metal layer obtained is maintained in a region overlapping the mask layer. In particular in order to be usable as a mask in the case of exposure with UV radiation, the mask layer preferably comprises UV blockers.

It is also possible that a resist lacquer, in particular an etching resist, preferably the partial lacquer layer as an etching resist, is provided as a mask layer on the metal layer in the first region, such that, during the demetallizing operation, the metal layer is maintained in the first region correspondingly to the resist lacquer, in particular etching resist, wherein, in particular, the resist lacquer, in particular etching resist, is not structured so as to follow the contour of the first image elements and/or of the first relief structures in the first region.

It is possible that, in particular in addition to the perfect register of second relief structures and partial metal layer in the second region, register tolerances exist in the first region, in particular between the first relief structures and the partial metal layer in the first region. In particular, it is possible that the partial metal layer in the first region exhibits register tolerances, in particular owing to the use of the mask layer or of the resist lacquer, in particular etching resist, or of the photoresist lacquer during the demetallizing of the metal layer. The register tolerances lie in particular in a range from 0.1 mm to 1.0 mm. The register tolerance is in particular the deviation of the relative position of the partial metal layer in relation to a target position, preferably in a view directed perpendicularly onto a plane spanned by the multilayer body. The target position of the partial metal layer may be predefined for example by the actual position of another layer, for example of the first relief structures. For example, if a region is partially protected against demetallization by means of an etching resist, this region exhibits a register deviation relative to the structure-based regions, because the etching resist is in particular introduced in an additional working step. Protection against forgery can thus be increased, for example because a perfect register can be demonstrated only for particular layers, whereas a defined register tolerance can be demonstrated for other layers.

The method for producing the multilayer body may in particular have one or more of the following steps, preferably in the stated sequence:
Providing the spacer layer, which is in particular a carrier layer. The spacer layer or carrier layer preferably has or consists of PET.
Providing a primer on the first side of the spacer layer or applying a primer to the first side of the spacer layer. A primer is in particular an adhesion promoter layer.
Coating the second side of the spacer layer with the mask layer in the form of a lacquer layer which blocks UV radiation, and which may optionally be colored. The mask layer may also be formed in parts, in particular in the form of a motif. It is thus possible to achieve protection of the metal layer in the first region against demetallization.
Coating the second side of the spacer layer, in particular of the spacer layer and of the mask layer, with the replication layer, preferably with an application weight in the range from 0.5 g/m² to 4 g/m².
Replicating the first and second relief structures and optionally further relief structures, for example the third relief structures described above, into the previously applied replication layer on its side facing away from the spacer layer. The replication is performed in particular by thermoplastic molding or by UV molding.
Coating the spacer layer, in particular the primer, on the first side with a further replication layer, in particular with an application weight in the range from 5 g/m² to 10 g/m².
Replicating the microlens array in the microlens region into the further replication layer applied to the first side of the spacer layer. The replication is performed in particular by thermoplastic molding or UV molding. The microlenses are preferably positioned in register with one or more of the following layers or elements: the first and/or second image elements, the mask layer, which is preferably a partial UV-radiation-blocking lacquer layer, which may optionally be colored. The microlens region, which is spanned by the microlens array, is preferably applied over the full area or only in parts, in particular in the form of a motif, in particular in a view directed perpendicularly onto a plane spanned by the multilayer body. It is also possible for the microlens array to be made up of a plurality of preferably different partial microlens arrays, as has in particular also been described in the statements above.
Applying, in particular by vapor deposition, a metal layer, for example comprising aluminum, to the replication layer that has the first and the second relief structure, whereby, in particular, the contrast generated by the relief structures can be increased.
Coating the metal layer with one or more photoresist lacquer layers. The photoresist lacquer layers are preferably applied over a full area, in particular in a view directed perpendicularly onto a plane spanned by the multilayer body. The layer thickness of the one or more photoresist lacquer layers preferably lies in a range from 0.3 μm to 1.5 μm, in particular after drying or curing.
Irradiating, in particular exposing, the one or more photoresist lacquer layers through the spacer layer, and preferably through the replication layer and the metal layer from the first side of the spacer layer, in particular using UV radiation. UV radiation is in particular radiation having wavelengths in a range from 100 nm to 380 nm.
Developing and structuring the one or more photoresist lacquer layers. During the structuring operation, in particular either the more intensely exposed or the less intensely exposed regions are removed.

It is possible that, in the first region, in particular in regions having the mask layer, in particular in the form of a printed UV blocker lacquer, as protection, the one or more photoresist lacquer layers are not exposed and are therefore not removed during the structuring operation, and the metal layer is not demetallized during the demetallizing operation. The microimage-microlens effect can thus be generated in this region or these regions preferably by means of, preferably exclusively by means of, the structure-based color effect, in particular contrast difference of different first relief structures. The adjoining and/or surrounding regions, in particular the second region, may be demetallized in accordance with other principles, such that the contrast can be generated therein for example by means of metal and transparency or metal and color transparency.

Alternatively or in addition to the coating with the mask layer, it is possible that, after the metal layer has been applied and before the metal layer is coated with the photoresist lacquer layers, a resist lacquer, in particular an etching resist, is applied, in particular printed, over the full area or in parts, in particular in the form of a motif, in the first region onto that side of the metal layer which faces away from the replication layer, wherein the resist lacquer, in particular etching resist, protects the metal layer during the demetallizing operation, such that the obtained partial metal layer in the first region is present in regions covered by the resist lacquer, in particular etching resist, in particular is present over the full area in the first region.

It is possible that one or more color lacquer layers are arranged, preferably printed, in the multilayer body, preferably are arranged in the first region and/or in the second region. In particular, one or more first color lacquer layers are provided in the multilayer body and are arranged, proceeding from the replication layer and/or the metal layer, on a side facing toward the microlens array, preferably are arranged between the metal layer and/or the replication layer and the microlens array. It is also possible that one or more second color lacquer layers are provided in the multilayer body and are arranged, proceeding from the replication layer and/or the metal layer, on a side facing away from the microlens array. It is also possible that one or more of the one or more color lacquer layers, in particular the first and/or second color lacquer layers, are monochromatic or polychromatic and/or have a color gradient, preferably having a screen density in a range from less than 100% to more than 0%.

By means of such color lacquer layers, it is possible to generate microimage-microlens effects with defined colors, wherein effects resulting from structure-based color effects, which are made possible by the first relief structure of the first image elements, optically have a clearly different appearance than effects generated by the second image elements with the second relief structure.

It is also possible that, in the second region and/or one or more second subregions, there are regions which do not have a metal layer and in which one or more color lacquer layers are preferably provided at least in certain regions.

It is also possible in particular to achieve the above object by means of a first multilayer body, which is preferably referred to here otherwise merely as multilayer body and/or is a multilayer body according to any one of the multilayer body claims, or by means of a second multilayer body and/or by means of a first method for producing a multilayer body, which is in particular referred to here otherwise merely as method and/or is a method according to any one of the method claims, or by means of a second method for producing a multilayer body.

The second multilayer body is in particular a security element, preferably produced by means of the second method. The second multilayer body comprises:
a spacer layer, in particular as a carrier ply, having a first side and having a second side situated opposite the first side;
a microlens array in a microlens region, wherein the microlens array is arranged on the first side of the spacer layer;
optionally a replication layer on the second side of the spacer layer;
optionally first relief structures, which are assigned to a plurality of first image elements which are arranged in a first region of the microlens region, wherein the first relief structures provide or generate structure-based colors and/or color effects, and/or optionally second relief structures, which are assigned to a plurality of second image elements, and optionally a partial lacquer layer, which is preferably assigned to a plurality of second image elements, wherein the second image elements are arranged in a second region, which is preferably separate from the first region, of the microlens region;
optionally a partial metal layer applied to the replication layer,
   wherein, in particular, in the second region, a contour of the partial metal layer follows a contour of one or more relief structures of the second relief structures and forms a contour of the second image elements, wherein, preferably, the contours of the partial metal layer are arranged in register with, preferably in perfect register and/or without a position tolerance relative to, the contours of the one or more relief structures of the second relief structures,
wherein, more preferably, in the first region, the partial metal layer is not provided or is present over the predominant part of the full area or over the full area, in particular such that the contour of a plurality of the first image elements is independent of the contour of the partial metal layer.

The second method is a method for producing a multilayer body, in particular a security element, preferably the second multilayer body, wherein the method comprises the following steps:
providing a spacer layer, in particular a carrier ply as a spacer layer, having a first side and having a second side situated opposite the first side;
providing or generating a microlens array in a microlens region, wherein the microlens array is arranged on the first side of the spacer layer;
optionally providing or generating a replication layer on the second side of the spacer layer;
optionally providing or generating first relief structures in the replication layer, wherein the first relief structures are assigned to a plurality of first image elements which are arranged in a first region of the microlens region, wherein the first relief structures are designed so as to generate or provide structure-based colors and/or color effects;
optionally providing or generating
a) second relief structures in the replication layer, wherein the second relief structures are assigned to a plurality of second image elements, and/or
b) a partial lacquer layer, which is preferably assigned to a plurality of second image elements, wherein the second image elements are arranged in a second region, which is preferably separate from the first region, of the microlens region;
optionally providing or generating a metal layer on the replication layer;
optionally demetallizing the metal layer using one or more of the second relief structures and optionally the partial lacquer layer as a mask, such that a partial metal layer is obtained, wherein, in the second region, a contour of the partial metal layer follows a contour of the second relief structures and forms a contour of the second image elements,
wherein, in particular, in the first region, the partial metal layer is maintained over the predominant part of the full area or over the full area, is completely removed, or is not provided, in particular such that the contour of a plurality of the first image elements is independent of the contour of the partial metal layer.

The components of the second multilayer body and of the second method and the steps of the second method may be configured as described with regard to the first multilayer body and with regard to the first method.

It is possible that, in the aforementioned first and/or second multilayer body or the aforementioned first and/or second method, one or more color lacquer layers, preferably all color lacquer layers which generate or provide a color or color change which is visible through the microlenses, and/or the first and/or second color lacquer layers, are printed in screened form, preferably exclusively in screened form, and in particular are not printed in full tone and/or are printed exclusively in halftone, preferably onto the spacer layer and/or onto a layer connected to the spacer layer. In particular, one or more, preferably all, of the color lacquer layers exhibit a color gradient and/or a color progression. It is optionally also possible for color lacquer layers without a color progression, in particular color lacquer layers of homogeneous color, and thus preferably color lacquer layers without visible edges, to be provided over a full area. Color gradients are in particular printed by printing preferably continuously varying screen densities. The particular color gradient can be produced in particular in that, in a view directed perpendicularly onto a plane spanned by the multilayer body, one or more screens having subregions, formed in particular by screen dots, of a color lacquer are applied with a gradient of a printed areal density of the subregions, that is to say in particular with an areal density of the subregions which increases or decreases in at least one direction. A color progression may be produced in particular by virtue of a plurality of color lacquers being applied with different screens and thus in particular forming one or more of the color lacquer layers. It is optionally possible here for one or more of the subregions to merge, in particular before curing. The subregions preferably do not merge. The resulting color lacquer layers are preferably transparent or semitransparent.

Through optimized configuration of the color print and the use of color progressions, for example, it is possible in particular to enhance the plastic effect or three-dimensionality of designs, for example through the imitation of light reflections and/or shadowing and/or perspectives. It is thus possible in particular for the color impression to be configured so as to logically supplement and support the optical appearance of the image information. For example, for the simulation of light and shadow, it should preferably be noted that regions of shadowing can be imitated by means of dark colors and high color intensity, and light reflections can be imitated by means of bright colors and low color intensity. It is thus possible, for example, for circular image elements to be provided with a three-dimensional spherical appearance.

When implementing color gradients, it should preferably be ensured that as homogeneous as possible a color progression is generated. It has proven to be advantageous to use not full tones but exclusively halftones, that is to say screened color layers. Full tone is to be understood in particular to mean a coherent, preferably substantially closed area of the particular color layer. It has been found in particular that, at a color progression of 100% screening, that is to say a full-tone print, with printed screen dots for example merging to form a solid area, to a print with 0% screening, that is to say no color application, two optically visible imperfections can be generated: firstly, the transition from a homogeneously filled color area (100%) to a region in which individual screen dots remain, that is to say for example no longer merge to form one area, and secondly, the undefined outline of the print at very low screen values (no further color application or transfer of color).

Preferably, one or more, preferably all, of the color lacquer layers are applied with an areal density in a range from 90% to 10%, preferably from 85% to 15%, even more preferably from 80% to 20%. Here, the one or more color lacquer layers are arranged in particular at least in the entire region which is visible through the microlens array, for example over the full area in the first and in the second region. The areal density or screen density is in particular the ratio of the surface area of the subregions, in particular screen dots, of the screen to the total area of a region of constant screening formed by the outer subregions, preferably during the application of the screen, preferably in a view directed perpendicularly onto a plane spanned by the multilayer body, or in a developed view of a printing roller or printing plate.

That is to say, in particular, full tones (100%) and free areas (0%) are preferably avoided, and instead, the entire area is covered with screen dots, wherein the area coverage with screen dots may then vary. It is thus possible in particular to generate a homogeneous color progression. It is thus possible to improve a perceptible positional accuracy, the optical impression and protection against forgery.

To achieve the aforementioned object, a printing device or a printing process is also conceivable, which printing device or printing process is in particular usable or used or carried out in the first and/or second method.

The printing device has in particular a plurality of tools for printing the one or more color lacquer layers, preferably all color lacquer layers, which provide or generate a color or color change which is visible through the microlenses, and at least one first tool of the plurality of tools has a different preferred direction than at least one second tool of the plurality of tools.

The printing process has in particular a plurality of printing steps, wherein, for each printing step, in each case one tool is used for printing one of the one or more color lacquer layers, wherein at least one first tool of the plurality of tools has a different preferred direction, in particular a different screen angle, than at least one second tool of the plurality of tools. In particular, at least a first printing step is thus carried out with a different preferred direction than at least one second printing step. In the printing process, preferably in each case one color lacquer layer is printed in each printing step, and preferably altogether all color lacquer layers which generate or provide a color or color change which is visible through the microlenses are printed.

It is advantageously thus possible to avoid interference effects such as the interfering formation of Moiré effects. The preferred direction of a color lacquer layer, which is printed in screened form, of the one or more color lacquer layers and/or of a printing screen of at least one first tool preferably differs, by a difference of the screen angle of at least +/−10°, from the preferred direction of a further color lacquer layer, which is printed in screened form and in particular constitutes a key color, of the one or more color lacquer layers, and/or from the preferred direction of a printing screen of at least one second tool, preferably for printing a key color.

It is possible that printed screens formed by a plurality of color lacquer layers are rotated relative to one another by a screen angle of +/−10° in the first and/or second multilayer body, or in the first and/or second method, and/or in the printing process, and/or by means of the printing device.

A tool, in particular the first and/or second tool, has at least one printing roller and/or a print head and/or a printing nozzle and/or a printing cliché and/or a printing plate. In particular, a tool may be a printing roller or a printing plate of a gravure printing device, a printing plate of an offset printing device, a printing plate of a flexographic printing device, and/or an inkjet printing device.

The printing device preferably has at least one feed device by means of which at least the carrier ply, which preferably serves as a spacer layer, optionally with further layers of the multilayer body, can be fed to the tools. For this purpose, the printing device may have one or more drums which are arranged and/or can be driven such that the carrier ply can be fed to the tools and away from the tools. The screen angle may in particular be controlled by the movement and/or control of a print head and/or of a printing nozzle, in particular in relation to the carrier ply, and/or by the arrangement of the screen on a printing cliché and/or a printing plate, in particular in relation to the carrier ply.

A preferred direction is to be understood in particular to mean the screen angle of the particular tool.

A key color is to be understood in particular to mean the color which is printed first during the printing of a plurality of colors, and relative to which the other colors are printed in register.

A preferred direction of the key color is to be understood in particular to mean the screen angle of the tool for printing the key color.

To achieve the aforementioned object, it is also possible that the printing process comprises one or more of the following steps:
printing a first color, in particular cyan,
printing a second color, in particular magenta,
printing a third color, in particular yellow,
wherein one or more of the first, second and third colors, preferably each printed color, are/is printed with color gradients. The color gradients are in particular printed by printing preferably continuously varying screen densities.

Also conceivable, therefore, is a multilayer body, in particular the first and/or second multilayer body, which comprises one or more of the following printed colors:
a first color, in particular cyan,
a second color, in particular magenta,
third color, in particular yellow, wherein one or more of the first, second and third colors, preferably each printed color, are/is printed with color gradients.

It is preferably possible that one or more of the first, second and third color are printed to form, or as, one or more of the one or more color lacquer layers of the multilayer body, in particular in the first and/or second region.

Preferably, a plurality of the first, second and third color are printed so as to overlap one another with opposite color gradients, in particular with an exactly opposite color gradient or with a color gradient which is opposite in one direction, wherein another direction is identical. The direction of the color gradient points in particular from a higher areal density of printed screen dots to a lower areal density of printed screen dots.

It is preferably also possible that one or more of the first, second and/or third color is printed with a screen density of less than 100% and greater than 0%, preferably in a range from 98% to 5%, preferably in a range from 80% to 15%.

It is in particular possible that the color lacquer layers printed with the first, second and/or third color are printed so as to overlap in a color gradient region, wherein, preferably, at least one of the colors is printed with a color gradient from the inside to the outside of the color gradient region.

It is thus advantageously possible in particular to generate homogeneous printed images, that is to say preferably to avoid optically visible sharp print edges. It is thus possible in particular to conceal register deviations or register tolerances that arise when printing a plurality of colors in register. For example, the second color, in particular red, is printed oppositely, with a screen density of 80% to 15%, in relation to the third color, in particular yellow, which is printed with a screen density of 15% to 80%. The two colors overlap for example in the color gradient region. The first color, in particular blue, is screened from 98% to 30% from the inside to the outside in the color gradient region, such that it is possible in particular to generate an optically homogeneous printed image. With regard to the areal density or screen density (avoiding 100% and 0%), reference is in particular also made to the statements made above.

A CMYK printing process is carried out in particular by means of a device which is suitable for printing the colors cyan (C), magenta (M) and yellow (Y), wherein, in particular, mixed colors of two or more of the three colors are printed or printable, and in particular the darkest color is printed or printable by means of a mixed color of the three colors. Here, the colors are applied or applicable by means of translucent color lacquers. K stands for “Key Color” and is formed in particular by an additional color, black, which forms the “key color”.

Translucent is to be understood in particular to mean transparent or semitransparent.

Most colors that are visible to the eye arise by virtue of a material surface absorbing certain wavelength ranges from the incident white light and reflecting only the rest (body color or surface color). The visible color results from the mixing ratio of the reflected wavelengths. This is referred to as subtractive color mixing, because certain colors are removed from the incident light. Subtractive color mixing also occurs when light passes through colored filters. Subtractive color mixing is in particular a basis for color printing in printing processes.

The primary colors are in particular cyan (C), magenta (M) and yellow (Y). Mixed colors can be generated by overprinting the colors on one another. Orange-red (R) is generated by overprinting yellow and magenta on one another, leaf green (G) is generated by overprinting yellow and cyan on one another, and violet blue (B) is generated by overprinting cyan and magenta on one another. The colors or color lacquers are in particular translucent (translucid=transparent or semitransparent). The color mixing situation thus makes it possible, in the production process, to generate a total of 6 colors by printing the three colors cyan (C), magenta (M) and yellow (Y).

When the colors cyan, magenta and yellow are mixed in equal parts, preferably all of the components of the white light should be absorbed, creating black when printed, though this is in particular often not achieved owing to the non-ideal physical properties of the pigments, and often results in particular in a dark brown. The additional color black (key color) is therefore expediently used to be able to form or reproduce a true black instead of dark brown in a printed image.

The contrast is preferably determined in the CIELAB color space by the total color difference dE. In particular, in the CIELAB system, the color space is represented by a sphere defined by the three axes brightness L, red-green axis a and yellow-blue axis b. In particular, L=100 corresponds to white, L=0 corresponds to black and L=50 corresponds to the achromatic point. The total color difference dE is furthermore determined as follows:

$$dE = {( {( d L )}^{2} + {( da )}^{2} + {( d b )}^{2} )}^{1 / 2} ,$$

where in particular “dL” is the brightness difference, the value “da” is the color difference on the red-green axis, and “db” is the color difference on the yellow-blue axis, between two colors.

Contrast is understood here preferably to mean the total color difference dE.

In general, in particular, the following applies: The smaller the difference, the smaller the color differences.

It is possible that one or more translucent color layers are arranged, in parts or over a full area, in front of or behind the partial metal layer in particular as seen in a view from the first side, that is to say from the side of the microlens array. In this regard, reference is in particular also made to the statements made above. These translucent color layers may directly adjoin the partial metal layer or may be spaced apart from the metal layer by a lacquer. The translucent color layer acts in particular as a colored foreground or background and thus as an optically contrasting region, and for a viewer generates a perceptible color impression in the corresponding coloration of the color layer.

In particular, it has been found to be advantageous for dE to have a value in a range from: 50 to 270; preferably 100 to 270; more preferably 130 to 270. Preferably, a dark color having a low L value is printed with lacquering first, and a color having a high L value is printed with lacquering second. It is thus possible that, preferably, at least one layer having a first brightness L is applied first, and at least one layer having a second brightness L is applied subsequently, wherein the first brightness is lower than the second brightness.

It is advantageous if a first translucent color layer, preferably of the one or more color layers, exhibits, in particular in a direct reflection over a tilt angle range from preferably at least 0° to 30° with respect to the normal to a plane spanned by the multilayer body, and/or over a tilt angle range from preferably at least 30° to 60° with respect to the normal to a plane spanned by the multilayer body, a total color difference dE in the CIELAB color space of 50 to 270, preferably of 100 to 270, more preferably of 130 to 270, with respect to the second and/or with respect to the third color layer.

It is also advantageous if the first translucent color layer, preferably of the one or more color lacquer layers, exhibits, in particular in a direct reflection over a tilt angle range from preferably at least 0° to 30° with respect to the normal and/or over a tilt angle range from preferably at least 30° to 60° with respect to the normal, a relatively dark color, in particular having a low brightness value L, and the second and/or third color and/or a second and/or third color lacquer, preferably of the one or more color lacquer layers, exhibits a relatively bright color, in particular having a relatively high brightness value L.

It is furthermore advantageous if the at least one translucent color layer, preferably of the one or more color lacquer layers, exhibits, in particular in a direct reflection over a tilt angle range from preferably at least 0° to 30° with respect to the normal to a plane spanned by the multilayer body and/or over a tilt angle range from preferably at least 30° to 60° with respect to the normal, a relatively bright color, in particular having a relatively high brightness value L, and the second and/or third color and/or a second and/or third color lacquer, preferably of the one or more color lacquer layers, exhibits a relatively dark color, in particular having a relatively low brightness value L.

The total color difference dE of regions having the metal layer in relation to regions without the metal layer preferably has a value in a range from: 10 to 270; preferably 15 to 250; more preferably 20 to 200.

If a plurality of color lacquers, in particular translucent color lacquers, are overprinted on one another, this provides the viewer with the visual impression of the mixed color in accordance with the principle of subtractive color mixing.

This can be used to form image elements in the second region optically in perfect register with another color.

In particular, it is possible that the spacer layer, preferably carrier ply, is colored, and/or that, preferably after the application of the primer, one or more first color lacquer layers are applied over the full area or in parts to the spacer layer, preferably carrier ply, in particular to the first and/or second side, in particular between microlens array and partial metal layer of the multilayer body. After the demetallizing operation, preferably after the irradiation, in particular exposure, of the one or more photoresist lacquer layers through the spacer layer, it is preferably possible to carry out the following step:
applying one or more second color lacquer layers to that side of the partial metal layer which faces away from the replication layer.

It is possible here that, in particular in a view directed perpendicularly onto a plane spanned by the multilayer body, at least one color lacquer layer of the one or more second color lacquer layers is applied in regions which overlap the partial metal layer and also in regions which do not overlap the partial metal layer, wherein, in particular, said at least one color lacquer layer is preferably arranged over the full area at least in the second region. Said at least one color lacquer layer can thus advantageously be applied such that, in regions which overlap the partial metal layer, a color impression is generated or provided which differs from a color impression in regions which do not overlap the partial metal layer.

It is thus possible in particular to produce a multilayer body which, in regions having the partial metal layer, exhibits a color impression of the one or more first color lacquer layers, and in regions without the partial metal layer, exhibits a color impression resulting from a mixed color of the one or more first color lacquer layers and of the one or more second color lacquer layers, preferably as seen in a view through the microlenses and/or in a view directed from the side of the microlens array onto the multilayer body. If yellow is used as a color of the first lacquer layers and blue is used as a color of the second lacquer layers, it is for example the case that green is formed as a mixed color in the regions without a metal layer. Here, in particular, there is no perceptible register deviation between the regions with and without a metal layer, which exhibit different color impressions.

Preferably, a color which is not too dark is selected for the one or more first color lacquer layers, in order to ensure an adequate contrast ratio.

It is also possible in particular to achieve the aforementioned object by means of a multilayer body, preferably the first and/or second multilayer body, and/or a method for producing a multilayer body, in particular the first and/or second method, wherein one or more motif layers are arranged in the multilayer body at least in certain regions outside the microlens region and adjacent to the microlens region and optionally so as to overlap the microlens region in certain regions, wherein the one or more motif layers are designed such that they overlap and/or logically supplement and/or complete a first item of image information, which is visible through the microlens array and is provided at least by the first and/or second image elements, with a further item of image information. In particular, the further item of image information is identical to at least a partial item of image information of the first item of image information and/or a scaled partial item of image information of the first item of image information and/or forms a motif together with at least one partial item of image information of the first item of image information and/or a scaled partial item of image information of the first item of image information, wherein the motif preferably constitutes a unit which forms a whole, such as a symbol, a geometrical shape, for example one or more hexagonal cells of a honeycomb, a logo, an emblem, a portrait, a QR code, a barcode.

Through the combination of the motif layers with the first and/or second image elements, it is possible to improve the design integration by virtue of motifs being continued in both regions, or supplementing or completing one another. This in particular increases protection against forgery and improves the optical impression.

The motif layers are preferably not assigned to the first or second image elements or other image element groups that would be provided for example for generating a microimage-microlens effect. The one or more motif layers are preferably formed by means of one or more color lacquer layers. They are in particular printed, in particular macroscopic, motif layers, preferably for providing a background color. The motif layers are for example printed with a resolution in a range from 300 dpi to 2540 dpi.

It is also possible that, in a multilayer body, in particular the first and/or second multilayer body, and/or in a method for producing a multilayer body, in particular the first and/or second method, the one or more motif layers are arranged in a transition region partially overlapping the microlens region, and outside the microlens region. It is possible here that, as part of the one or more motif layers, in particular the first relief structures, the second relief structures and/or the third relief structures, which preferably comprise microstructures and/or diffractive structures, are formed in the replication layer. The third relief structures may be a combination and/or a superposition of the first and second relief structures or a combination of structures described with regard to the first and second relief structures and/or a superposition thereof. With regard to the third relief structures, reference is made in particular to the statements above. The motif layers, in particular the third relief structures, are preferably not assigned to the first or second image elements or other image element groups that would be provided for example for generating a microimage-microlens effect. In particular, the parts of the motif layers having the third relief structures have a minimum width of 1 mm, preferably 3 mm, more preferably 5 mm, preferably in a view directed perpendicularly onto a plane spanned by the multilayer body. A width of the transition region is preferably less than 3 mm, particularly preferably less than 2 mm, particularly preferably less than 1 mm and more preferably less than 0.5 mm, preferably in a view directed perpendicularly onto a plane spanned by the multilayer body. The smaller the transition region, the more defined and thus understandable to laypersons are the optical effects in the two regions outside and inside the microlens region. The width of the transition region is in particular dependent on tolerances in the production process.

It is thus possible in particular for a further design element to be introduced which overlaps the microlens region. It is possible for the multilayer body to have regions having, for example classic, structure-based effects, in particular a preferably macroscopic design without microimage information, and regions having microlens-based effects, for example in the first and/or second region. Here, a transition region may arise in particular in the case of combined implementations of classic structure-based effects and microlens-based effects. This is dependent inter alia on the production tolerances, inter alia in the replication step of the microlenses and in the formation of the first and second image elements.

For example, superpositions of the structure-based effects and of the microlens array occur in the transition region. In at least one subregion of the transition region, however, it is advantageously the case that no optically in particular three-dimensional movement pattern arises, for example because the one or more motif layers overlap a coherent plurality of microlenses over a full area, such that the structure of the motif layers which is seen through this plurality of microlenses is independent of the viewing angle. Furthermore, in particular, effects of the third relief structure, in particular diffractive effects, are lessened, in particular significantly, by the microlenses, and primarily the macroscopic partial metal plating under the microlens array can be seen. It is thus possible by means of the third relief structure to provide, in particular in the same working step, an optical security feature which generates a plurality of optical effects, specifically for example an optically variable effect and an optically invariant or approximately invariant effect. This in particular increases protection against forgery, whilst the outlay on production can advantageously be kept low.

It is also possible to conceal the at least one subregion of the transition region. Preferably, the shaping of the one or more motif layers of the third region, in particular of the third relief structure, is integrated into and/or formed similarly to an outer contour of the microlens array, in particular in a view directed perpendicularly onto a plane spanned by the multilayer body, and/or is integrated into and/or formed similarly to the optical effect of the microlens region. It is also possible to provide for static elements of a partial metal plating of the third region, in particular on the third relief structure, to transition into the adjoining microlens region. In particular, it is possible for the third relief structure with a partial metal layer arranged thereon to be provided, in the transition region, in the form of one or more of the following motifs: guilloches, lines, geometrical shapes, alphanumeric characters, or the like.

Diffractive effects which are generated in the microlens region are lessened in particular by the microlenses arranged thereabove, for example by scattering. It is thus preferably possible for filigree diffractive effects such as fine line movements to be more faintly discernible from the front side when combined with microlens effects, that is to say through the microlenses. However, if the microlens region is placed onto a window region of the multilayer body or of a security document, then these filigree effects are clearly visible from the rear side. This results in a security element which exhibits the microlens effects, and does not show or only very faintly shows the filigree diffractive effects, when viewed from the front side and/or when seen in a view directed through the microlenses onto the first and/or second image elements. At the same time, when viewed from the rear side, the filigree diffractive effects are very clearly visible and at the same time conceal the appearance of the image information, which appears irregular and therefore unattractive to the human eye.

Preferably, the second relief structures and/or the third relief structures and/or further relief structures in the replication layer have one or more diffractive relief structures which are arranged in a window region and are preferably provided with the partial metal layer. These one or more diffractive relief structures, preferably with the partial metal layer, particularly preferably constitute filigree diffractive elements. These one or more diffractive relief structures furthermore preferably provide diffractive lines in at least 50% of the area of a window region, preferably in more than 75% of the area and particularly preferably in more than 90% of the area, and/or have a width of less than 75 μm, more preferably less than 60 μm and particularly preferably less than 50 μm. The minimum width is preferably 20 μm The density of the preferably filigree diffractive effects in the window region is furthermore preferably as homogeneous as possible. In the window region, the areal density, in particular in a view directed perpendicularly onto a plane spanned by the multilayer body, preferably in relation to a total area formed by the window region, fluctuates particularly preferably at most by ±20% and particularly preferably at most by +10%. The areal density of the preferably filigree diffractive elements in the window region is preferably less than 30%, more preferably less than 20% and particularly preferably less than 10%.

A window region is in particular a transparent and/or cut-out region of the multilayer body and/or of the security document and/or has transparent and/or cut-out regions, preferably where no layers for generating an optical effect are arranged.

In a preferred embodiment, it is possible for the first and second image elements to be formed by means of relief structures, in particular by means of subwavelength gratings. Here, the partial metal layer is present over the full area in the first region and is in particular opaque. The metal layer, for example aluminum, preferably with an optical density OD in a range from 1.9 to 1.65, is applied to these structures in the first region and functions in particular as a reflection layer, preferably for a thin-film effect structure. Further metals that can be used as a reflection layer are for example Cr, Cu, Sn, Ag, Ni, Au, Fe or alloys thereof. It is possible for a dielectric spacer layer to be applied to the reflection layer, for example by sputtering, PVD, CVD, gravure printing, flexographic printing, inkjet printing. As a dielectric spacer layer, use may for example be made of SiO₂, in particular with a layer thickness in a range from 300 nm to 600 nm; MgF₂, ZrO₂, ZnS, indium tin oxide (ITO). The dielectric spacer layer may alternatively also be lacquered by gravure printing, flexographic printing and/or offset printing. The dielectric spacer layer is preferably structurable or washable, that is to say can be or is structured with a barrier font or a photoresist. A partially transparent metallic absorber layer (semitransparent) having an optical density OD in a range from 0.3 OD to 0.6 OD, for example chromium or aluminum, is applied to the dielectric spacer layer. One or more of the following materials may in particular be used as an absorber layer: aluminum, chromium, iron, gold, copper, titanium, nickel, cobalt, tungsten, niobium, metal fluorides, oxides, sulfides, nitrides, carbides, phosphides, selenides, silicides and compounds thereof, or else carbon, germanium, cermet, iron oxide. The layer thickness of the absorber layer preferably lies in a range from 4 nm to 20 nm.

In the case of this structure, the interference color of the thin-film effect is preferably visible only from the rear side, whereas the structure-based microlens effect is visible from the front side.

A carrier ply or carrier layer is preferably understood to mean a single-layer or multilayer foil, the one or more layers of which consist in particular of the following materials or combinations thereof: PET (polyethylene terephthalate), PP (polypropylene), PE (polyethylene), PEN (polyethylene naphthalate), PC (polycarbonate), PVC (polyvinyl chloride), Kapton (poly-oxydiphenylene-pyromellitimide) or other polyimides, PLA (polylactate), PMMA (polymethyl methacrylate) or ABS (acrylonitrile butadiene styrene). The carrier ply may in particular have further spacer layers in order to adapt the multilayer body to the focal length of the microlenses.

The carrier ply itself may have a primer or an adhesion promoter layer. Said adhesion promoter layer is applied during the course of the production of the carrier.

The layer thickness of the adhesion promoter layer of a carrier ply preferably lies in the nanometer range. As an adhesion promoter layer, use may be made in particular of the materials mentioned below (see the point primer/adhesion promoter layer). The layer thickness of the carrier ply lies in particular between 1 μm to 500 μm, preferably between 6 μm to 75 μm, more preferably between 12 μm to 50 μm. In the method and the multilayer body, the spacer layer is preferably a carrier ply as described above.

A primer or an adhesion promoter layer in particular increases the adhesion between two layers that would otherwise exhibit inadequate adhesion to one another. This may for example be the adhesion of the replication layer to the spacer layer, in particular carrier ply. A primer is preferably a layer consisting of or comprising polyester, polyacrylate, polymethacrylate, polyurethane, polystyrene, polybutyrate, nitrocellulose, polyvinyl chloride, ethylene vinyl acetate, the copolymers thereof, or similar polymers or mixtures thereof. The primer may be thermoplastic, chemically cross-linking, UV-curable or in the form of a hybrid variant (thermoplastic and UV-curable and/or cross-linking by some other process), cold-setting adhesive/primer, or self-adhesive primer. The layer thickness preferably lies in a range from 0.01 μm to 15 μm, preferably from 0.1 μm to 5 μm. Inorganic materials such as metals, metal oxides, alloys, oxides or silicates can also serve as adhesion promoters or be part of such a system.

The adhesion promoter may also contain additives based on organic or inorganic substances which the processing properties, for example during the application of a lacquer layer in the above method or during the use of the security element itself, achieve a predetermined effect. The fraction of additives in the lacquer as a whole is preferably 0% and 10%, preferably 0% and 5%, more preferably between 0.01 and 3%. It is also possible for the formulation of a primer to include fillers. This preferably encompasses all further materials added to a system, in particular a polymer-based system, such as silica, pigments, dyes, tracers, in particular taggants, and/or similar materials. The proportion of fillers in the lacquer as a whole is in this case normally 0% to 80%. Adhesion promoters can also be formulated so as to be tacky to liquid even after the solvent has evaporated off and/or before fully curing. This is advantageous in particular if two substrates are to be connected to one another over a large area, as is commonly the case during a laminating process. The increase of the adhesion between the spacer layer, in particular the carrier ply, and replication layer may optionally also be achieved by means of surface-activating processes, in particular corona or plasma treatment. These are also usable in combination with an adhesion promoter.

A replication layer is understood here preferably to mean a special functional layer, in particular a lacquer layer, into which optically variable structures are formed and/or fixed in particular by thermal replication and/or UV replication. It is also possible for the replication layer to be a hybrid replication layer. In the case of a hybrid replication layer, this is for example thermally replicated and subsequently cured by radiation, for example by UV radiation and/or at least one electron beam. In the case of a UV-based replication layer, this is preferably replicated at room temperature and subsequently cured by radiation, for example by UV radiation and/or at least one electron beam. For example, it is possible that the lacquer is heated during a UV replication process. The replication layer has in particular a layer thickness of between 0.1 μm and 30 μm, preferably between 0.3 μm and 20 μm.

The microlens array is formed in particular by a plurality of microlenses arranged as an array. The microlenses have in particular a lens focal length of between 10 μm and 50 μm, preferably between 15 μm and 40 μm. It is furthermore expedient if the array of the plurality of microlenses arranged as an array has a period of between 5 μm and 70 μm, preferably between 5 μm and 50 μm, more preferably between 10 μm and 40 μm, and/or if the plurality of microlenses arranged as an array have a lens diameter of between 5 μm and 70 μm, preferably between 5 μm and 50 μm, more preferably between 10 μm and 40 μm. The microlenses preferably have a hemispherical geometry and/or a flattened hemispherical geometry and/or a similar geometry. It is also conceivable that the array of the plurality of microlenses arranged as an array is a one-dimensional or two-dimensional array. It is also conceivable that, in particular in the case of a two-dimensional array, the microlenses are arranged in offset rows, preferably with an offset of one half of a lens diameter and/or lens spacing.

The metal layer and/or partial metal layer which is used in particular for providing and/or intensifying the optical effects of the first and/or second image elements preferably comprises or consists of one or more of the following metals: aluminum, silver, chromium, copper, tin, gold, zinc or an alloy of the aforementioned metals. It is also possible that the metal layer and/or the partial metal layer consists of or comprises blackened aluminum, that is to say substoichiometric AlₓO_{y}, or of blackened silver by oxidation.

The metal layer is formed for example by vapor deposition or sputtering. The metal layer and/or the partial metal layer is preferably formed as an opaque or semitransparent layer. The opaque layer may function as a metallic mirror layer, or the semitransparent layer may function as an absorber layer. The layer thickness of the metal layer and/or of the partial metal layer preferably lies between 1 nm and 500 nm, more preferably between 5 nm and 100 nm. Said layer can typically serve as a metallic mirror layer above a layer thickness of 15 nm. In the case of a layer thickness of less than 15 nm, said layer can function as a semitransparent absorber layer. It is also possible for such a layer to be formed by the application of lacquers containing metal pigment and/or flakes, wherein the layer thickness lies in particular between 0.1 μm to 50 μm, preferably from 1 μm to 20 μm.

The photoresist lacquer layer is preferably formed from a negative or a positive photoresist. A positive photoresist is distinguished in particular by the fact that, with sufficient exposure to a suitable wavelength, for example to UV radiation, this lacquer becomes soluble in a particular solvent, for example acidic or basic aqueous solutions, in the exposed regions. By masked exposure, it is consequently possible to realize, in particular colored, regions of a defined shape and size.

Typical constituents of a photoresist lacquer layer are preferably one or more of the following:
1) Condensation polymer consisting of m- and p-Cresol and formaldehyde: novolac resin
2) Diazonaphthoquinone derivative (DNQ)
3) Solvent or solvent mixture, for example 1-Methoxy-2-propyl acetate

Novolac resins are hydrophilic (OH groups) and soluble in aqueous bases. It is possible to mix novolac resins with DNQ, whereby the solubility of the novolac in bases is reduced. Exposure of the inhibitor (DNQ) gives rise in particular to the acid, which enables the exposed parts (A) of the photoresist to be selectively dissolved by aqueous bases (developers). Following exposure, DNQ is converted into indolecarboxylic acid (ICA). This is hydrophilic and ionizable. This photoresist is preferably colored with Orasol dye or Microlith color pigments.

A negative photoresist is distinguished in particular by the fact that, with sufficient exposure to a suitable wavelength, for example to UV radiation, this lacquer cures and thus becomes insoluble in a particular solvent, for example acidic or basic aqueous solutions, in the exposed regions. By masked exposure, it is consequently possible to realize, preferably colored, regions of a defined shape and size.

As a negative photoresist, use is preferably made of a lacquer based on epoxy resins. The main constituents of a negative photoresist based on epoxy resins are generally low-molecular organic compounds that have more than one epoxy group per molecule. Preferably, as resin component for photoresist production, one or more of the following materials are used: epoxy resins based on bisphenol-A, epoxidized phenol novolac, diglycidyl resorcinol ether and resins of cycloaliphatic structure.

In conjunction with a cross-linker (curing agent), it is possible in particular for the so-called resin/curing agent system to provide a macromolecular network by polymerization of the epoxy group. Here, different curing agents may be used, which differ in terms of the ring-opening reaction of the oxirane groups. Preferably, acid anhydrides, amines or phenol-containing compounds are used, or triarylsulfonium salts are used as photoactive component.

Use is preferably also made of catalysts such as Lewis bases and acids. The curing agent is in particular incorporated into the three-dimensional network structure. In the case of a basic accelerator, the catalyst expediently promotes network formation by means of ester bridges.

Gamma-butyrolactone is preferably used as a solvent in the printing ink of such epoxy-resin-based photoresists.

Use is preferably also made of additives such as long-chain epoxy resins in order to serve firstly as an adhesion promoter, reactive thinner and/or as an additive or for lowering the viscosity.

For example, as a negative photoresist, use may be made of the photoresist SU-8 epoxy novolac based on bisphenol A; triarylsulfonium hexafluoroantimonate; gamma-butyrolactone (marketed for example by MicroChem Corporation, now Kayaku Advanced Materials, Newton, MA 02464, United States). This photoresist is preferably colored with Orasol dye or Microlith color pigments.

Water-based negative photoresists may for example be colored with Luconyl.

The total thickness of such layers is preferably no more than 15 μm, more preferably no more than 5 μm.

An example of a negative photoresist is as follows:

A combination of solvent and binder. The binder is in particular a combination of different acrylates (monomers and oligomers).

An example of a negative photoresist structure has or is formed from the following constituents:
Solvent: 1-Methoxy-2-propanol, fraction: 75%
Binder: Urethane acrylate oligomer 15%
Binder: Pentaerythritol tetraacrylate 2.5%
Binder: Pentaerythritol triacrylate 1%
Binder: Ethoxylated trimethylolpropane triacrylate 1%
Binder: Acrylated oligomer 2.5%
Curing agent: Genocure ITX 3%

The photoresist may be colored. The photoresist may with at least one pigment or one colorant, in particular of the color cyan, magenta, yellow or black (CMYK=Cyan Magenta Yellow Key: black as color depth), or the color red, green or blue (RGB), preferably in order to generate a subtractive mixed color.

As an alternative to the mixed color, use may also be made of pigments or dyes which generate a special premixed as a special color or as a color from a specific color system (for example RAL, HKS, Pantone®), for example orange or violet.

It is possible in particular that the partial metal layer, for example in the form of an aluminum layer, makes the presented image information colored by means of one or more color lacquer layers which are arranged behind said metal layer as seen by a viewer looking at the metal layer through the microlenses. It is also possible to generate a polychromatic item of image information by applying a plurality of differently colored color lacquer layers. In particular if the metal layer itself is not colored, a viewer sees items of image information which appear metallic, for example which appear silver-colored in the case of aluminum, on a colored background. If the metal layer is colored, for example by means of a color lacquer layer which has UV blockers and is used as a mask for the demetallizing operation, the viewer sees items of image information in one color on a differently colored background.

A color lacquer layer preferably consists of a binder, an additive, fillers. A color layer or color lacquer layer is preferably understood to mean a special functional layer which in particular generates a color impression perceptible to a viewer, and/or which is more preferably used as a mask layer. A color is understood in particular to mean a coloration which, with regard to transparency and/or clarity and/or scattering power, preferably comprises glass-clear transparent coloration, scattering transparent coloration or opaque coloration. The color preferably arises as the intrinsic color of a material and/or is arranged as an additional colored layer in front of a layer in a viewing direction, wherein the underlying layer is in particular modified in terms of its color appearance to a user. The color of a color lacquer layer preferably has an optically constant or invariant appearance in terms of its hue and/or its color saturation and/or its transparency at virtually all, in particular at all, viewing and/or illumination angles. It is furthermore possible that the color itself is optically variable, wherein the hue and/or the color saturation and/or the transparency of the color in particular changes with changing viewing and/or illumination angle.

The color layer is preferably in the form of a translucent color layer, in particular a transparent or translucently translucid color layer. The color layer furthermore preferably contains an additive which preferably absorbs light in the ultraviolet wavelength range, in particular in a wavelength range between 200 nm and 380 nm. Such UV blockers preferably enhance the function of the color layer as a mask layer. In particular, in the wavelength range of 380 nm to 780 nm, which is visible to the human eye, the UV blockers exhibit no absorption or only very little absorption, in particular so as not to change the color impression of the color layer.

Binders are preferably understood to mean polymer-based systems and the mixtures thereof, for example polyester, polyacrylate, polymethacrylate, polyurethane, polystyrene, polybutyrate, nitrocellulose, polyvinyl chloride, ethylene vinyl acetate, the copolymers thereof, or similar polymers.

Additives are preferably understood to mean organic or inorganic substances which the processing properties, for example during the application of a color layer in the above method or during the use of the security element itself, achieve a predetermined effect.

Fillers are preferably understood to mean all further materials added to a system, in particular a polymer-based system, such as silica, pigments, dyes, UV blockers (UV=UV radiation=ultraviolet radiation=electromagnetic radiation from the ultraviolet part of the spectrum of electromagnetic radiation or from one or more sub-ranges from the ultraviolet part of the spectrum of electromagnetic radiation), tracers, in particular taggants, and/or similar materials.

As color-imparting substances of the one or more color lacquer layers, in particular of the first and/or second color layer and/or of the first and/or second color lacquer layer, use is preferably made of dyes and/or pigments. Pigments are preferably practically insoluble, in particular insoluble, in medium into which they are integrated. Dyes preferably dissolve, and in particular lose their crystal and/or particle structure, during use. Possible classes of dyes are basic dyes, fat-soluble dyes or metal-complex dyes. Possible classes of pigments are organic and inorganic pigments. Pigments are preferably constructed from a material which is present in monolithic form, or in particular alternatively have complex structures, for example in the form of a layered structure having a plurality of layers consisting of different materials, and/or for example in the form of capsules consisting of different materials, in particular having a core and a casing.

The colors of the one or more color lacquer layers, in particular of the first and/or second color layer, are in particular transparent or at least translucent, wherein the transmissivity preferably lies between 5% and 99%, in particular over a sub-range of the wavelength range from 380 nm to 780 nm, which is visible to the human eye, preferably in the range from 430 nm to 690 nm. In particular, optically variable effects of the first and/or second optically variable structures are perceptible, said structures being arranged under the first and/or second color layer as seen in the viewing direction of the viewer.

It is also possible that the one or more color lacquer layers, in particular the first color layer and/or the second color layer, are formed from and/or consist of a plurality of different colors, wherein said layers preferably also have regions with a color mixture of the first and second colors, which arise as a result of overlap of the first and second color layers and/or as a result of screening of the first and second color layers. In particular, the color saturation in the first and/or second color layer varies.

The color lacquer may with at least one pigment or one colorant of the color cyan, magenta, yellow or black (CMYK=Cyan Magenta Yellow Key: black as color depth), or the color red, green or blue (RGB), in particular in order to generate a subtractive mixed color.

As an alternative to the mixed color, use may also be made of pigments or dyes which generate a special premixed as a special color or as a color from a specific color system (for example RAL, HKS, Pantone®), for example orange or violet.

The layer thickness of a color lacquer layer, in particular of the first and/or second color lacquer layer, lies in particular in a range from 0.1 μm to 10 μm, preferably from 0.1 μm to 5 μm.

It is possible that one or more of the color lacquer layers and/or the mask layer have UV blockers, for example organic UV absorbers, in particular benzotriazole derivatives, preferably with a mass fraction in a range from approximately 3% to 5%, in particular if the material of the corresponding color lacquer layer contains an insufficient quantity of UV-absorbing constituents, such as UV-absorbing pigments or UV-absorbing dyes. Suitable organic UV absorbers are marketed by BASF under the trade name Tinuvin®.

The mask layer as a partial lacquer layer, preferably transparent partial lacquer layer, having the UV blocker is preferably selected such that it can be removed using the same developer solution or the same solvent as for the photoresist lacquer. It is thus possible that the photoresist lacquer layer, where it remains, protects the partial lacquer layer. It is thus possible in particular for finely structured regions to be formed, preferably on the second side of the spacer layer, in particular on the replication layer together with partial metal layer, which regions for example have the UV blocker layer and the colored photoresist lacquer layer, and in particular, regions without these two layers are formed.

The multilayer body, in particular the security element, may additionally be provided with a machine-readable security feature in the form of magnetic materials of identical or different coercivities, which are present in a plurality of printing inks in a plurality of regions of identical and/or different remanence on a carrier substrate. The magnetic layer may be applied as a color layer before or after the generation of the metal layer and/or demetallization of the metal layer, as an item of image information, in particular as image elements, preferably first and/or second image elements, of the microimages, or as a separate layer.

The magnetic layer may be applied both over a full area and as a decoration, that is to say preferably in parts and/or in the form of a motif. The magnetic lacquers having the different coercivities may be applied individually in one region, one behind the other with a certain spacing in one region, and/or one on top of the other (so-called combi bits).

The application may be performed by means of one or more of the following printing methods: pad printing, offset printing, digital printing, flexographic printing, thermosublimation printing, thermal transfer printing, gravure printing, by means of slot dies, and/or screen printing. The applied layer thickness preferably lies between 0.1 μm and 25 μm, preferably between 4 μm and 20 μm, more preferably between 5 μm and 17 μm. The magnetic lacquer consists in particular of different components. Ferromagnetic ceramic materials are preferably used for this purpose. These may have different properties and strengths depending on the application. Ferrites are particularly preferably used. These may have different compositions. Main constituents are in particular hematite (Fe₂O₃) and magnetite (Fe₃O₄) and further metal oxides. Further constituents may be nickel (Ni), zinc (Zn), manganese (Mn), cobalt (Co), copper (Cu), magnesium (Mg), cadmium (Cd), barium (Ba), strontium (Sr). The fraction of the magnetic component in the lacquer as a whole preferably lies between 20% and 80%, preferably between 30% and 50%.

Materials of more than 1500 Oe are materials of high coercivity. 1 Oe (Oersted) corresponds in particular to 79.5774715 A/m.

The coercivity of the materials is preferably 3500 Oe±30%, preferably +20%, particularly preferably +10%.

Materials of <500 Oe are materials of low coercivity.

The coercivity of the materials is preferably 250 Oe±30%, preferably +20%, particularly preferably +10%.

Use may also be made of materials having a coercivity of 1000 Oe±30%, preferably ±20%, particularly preferably +10%.

A binder is also preferably used. Additives and fillers may additionally be present.

Binders are preferably understood to mean polymer-based systems and the mixtures thereof, for example polyester, polyacrylate, polymethacrylate, polyurethane, polystyrene, polybutyrate, nitrocellulose, polyvinyl chloride, ethylene vinyl acetate, the copolymers thereof, or similar polymers. It is advantageous if the fraction of the binder in the lacquer as a whole is between 3% and 50%, preferably between 5% and 30%, more preferably between 7% and 20%.

Additives are preferably understood to mean organic or inorganic substances which the processing properties, for example during the application of a lacquer layer in the above method or during the use of the security element itself, achieve a predetermined effect. The fraction of additives in the lacquer as a whole is normally 0% and 10%, preferably 0% and 5%, more preferably between 0.01% and 3%.

Fillers are preferably understood to mean all further materials added to a system, in particular a polymer-based system, such as silica, pigments, dyes, tracers, in particular taggants, and/or similar materials. The proportion of fillers in the lacquer as a whole is normally 0% to 40%.

If the magnetic layer is applied behind or directly in front of a metal plating, in particular the metal layer or the partial metal layer, as seen in a view of the multilayer body through the microlens array or from the first side, then at least one protective layer for protecting against corrosion is normally applied, in particular such that the protective layer is arranged between the magnetic layer and metal plating. The protection is particularly expedient if, for example, aluminum is used as a metal plating and would be in direct contact with the magnetic lacquer layer. It is however possible to omit said protective layer in particular if chromium, copper, silver, gold or alloys of these are used as a metal plating.

Said protective layer constitutes a barrier between the metal plating and the magnetic lacquer layer and consists of various components.

Said protective layer preferably consists of one or more binders, one or more additives, and fillers.

Binders are preferably understood to mean polymer-based systems and the mixtures thereof, for example polyester, polyacrylate, polymethacrylate, polyurethane, polystyrene, polybutyrate, nitrocellulose, polyvinyl chloride, ethylene vinyl acetate, the copolymers thereof, or similar polymers. It is advantageous if the fraction of the binder in the lacquer as a whole is between 3% and 50%, preferably between 5% and 30%, more preferably between 7% and 25%.

Additives are preferably understood to mean organic or inorganic substances which the processing properties, for example during the application of a lacquer layer in the above method or during the use of the security element itself, achieve a predetermined effect. The fraction of additives in the lacquer as a whole is normally 0% and 10%, preferably 0% and 5%, more preferably between 0.01 and 3%.

Fillers are preferably understood to mean all further materials added to a system, in particular a polymer-based system, such as silica, pigments, dyes, tracers, in particular taggants, and/or similar materials. The proportion of fillers in the lacquer as a whole is in this case normally 0% to 80%.

The layer thickness of the protective lacquer for protecting against corrosion lies in particular between 0.1 μm to 30 μm, preferably between 0.1 μm and 10 μm, more preferably between 0.1 μm and 5 μm.

It is also conceivable, in particular for the replication layer and/or the partial lacquer layer and/or the mask layer and/or one or more color lacquer layers, to use a lacquer which has fluorescent substances which are excited in particular by UV radiation, preferably from the wavelength range between 200 nm and 380 nm. It is thus made possible in particular that, under irradiation with UV radiation, visible light is coupled out.

The fluorescent substances are preferably raw materials with the type designation Lumilux from Honeywell, such as Lumilux CD 397 (fluorescent yellow), Lumilux CD 710 (fluorescent blue), Lumilux CD 702 (fluorescent green).

Use may also be made of perylene dyes, for example Lumogen F types, Lumogen F Red 305, Lumogen F Yellow 170, Lumogen F Pink 285, Lumogen F Orange 240 or Lumogen F Yellow 083, from BASF, Ludwigshafen, Germany. It is also possible for the fluorescent substances to be phosphorus S6, Uvitex OB/Tinopal OB, Uvitex FP, fluorescent orange, fluorescent yellow, fluorescent red, Lumilux Red CD120, Lumilux Yellow Orange CD130, Lumilux Effect Sipi Yellow, Lumilux Green CD116 or FTX Series Laser Red Code FTX-3.

It is advantageous if the proportion of fluorescent dye to binder is between 0.01% to 20%, preferably between 0.1% and 15%, more preferably between 0.2% and 10%, wherein, in particular, as binder, use is made of polyacrylates, polyurethanes, epoxies, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ethers, vinyl acetate, alkyl vinyl ethers, conjugated dienes, styrene, acrylates and/or copolymer resins or mixtures thereof.

Furthermore, individual raw materials may be used which are excited in a specific wavelength range by UV radiation in the ranges 380 nm to 315 nm (UV-A), 315 nm to 280 nm (UV-B), 280 nm to 200 nm (UV-C) or IR radiation, and emit in the visible range. For this purpose, the following materials may be added to a luminescence layer.

As raw materials, the following UV-excitable inorganic materials consisting of one or more foreign ions and a fundamental lattice may be used:

The following foreign ions or combinations may be used. Rare-earth ions and/or ions of transition metals such as: Pr³⁺, Sm³⁺, Eu³⁺, Tb³⁺, Er³⁺, Dy³⁺, Tm³⁺, Cr³⁺, Mn⁴⁺, Mn²⁺, Cu⁺, Ag⁺, Sn²⁺, Sb³⁺, Pb²⁺, Bi³⁺, Ce³⁺ and Eu²⁺ contained.

Fundamental lattice: borates (e.g. LaBO₃, SrB₆O₁₀, CaYO₄, SrB₄O₇, YAl₃B)₄O₁₂, SrB₈O₁₃, Ca₂B₅O₉Br), nitrides (e.g. CaAlSIN₃, Sr₂Si₅N₈, MgSiN₂, GaN), oxynitrides (e.g. SrSi₂N₂O₂, α-SiAlON, β-SiAlON, oxides (e.g. Al₂O₃, CaO, Sc₂O₃, TiO₂, ZnO, Y₂O₃, ZrO₂, La₂O₃, Gd₂O₃, Lu₂O₃), halides and oxyhalides (e.g. CaF₂, CaCl₂), K₂SiF₆, LaOBr), aluminates (e.g. LiAlO₃, SrAl₂O₄, Y₃Al₅O₁₂, BaMgAl₁₁O₁₇, CaAl₂O₄, Sr₄Al₁₄O₂₅), silicates (e.g. Ba₂SiO₄, Sr₃SiO₅, Sr₃MgSi₂O₈, Sr₂MgSi₂O₇, CaSiO₃, Zn₂SiO₄, Ba₂SiO₄, Y₂SiO₅, CaMgSi₂O₆, Ba₂Li₂Si₂O₇, LiCeBa₄Si₄O₁₄, Ca₃Al₂Si₃O₁₂), halosilicates (e.g. LaSiO₃Cl, Ba₅SiO₄Cl₆, Sr₅Si₄O₁₀Cl₆), phosphates (e.g. YPO₄, Ca₂P₂O₇, MgBaP₂O₇, Ca₃(PO₄)₂, MgBa₂(PO₄)₂), halophosphates (e.g. Ca₅(PO₄)₃Cl, Sr₅(PO₄)₃Cl), sulfides (e.g. ZnS, CaS, SrS, BaS, SrGa₂S₄, ZnGa₂S₄, ZnBa₂S₃), oxysulfides (e.g. Y₂O₂S, La₂O₂S, Gd₂O₂S, Lu₂O₂S), sulfates (e.g. Mg₂Ca(SO₄)₃), gallates (e.g. Y₃Ga₅O₁₂, CaGa₂O₄, Gd₃Ga₅O₁₂), vanadates (e.g. B. YVO₄), molybdates and tungstates (e.g. CaMoO₄, Sr₃WO₆, La₂W₃O₁₂, Tb₂Mo₃O₁₂, Li₃Ba₂La₃(MoO₄)₈), or inorganic substance classes such as borides, carbides, scandates, titanates, germanates and yttrates.

It is also conceivable, in particular for the replication layer, the partial lacquer layer, the mask layer and/or one or more color lacquer layers, to use a lacquer that comprises luminescent substances.

If, for example, Lumilux CD 397 (fluorescent yellow) is mixed into a red color lacquer applied in the decoration, then under visible light the user sees a red color printed in the decoration. Under UV irradiation, fluorescent yellow light is emitted, wherein the red color lacquer acts as a color filter for the yellow light, resulting in an orange color being visible in the decoration. If this effect is combined with a region in which only Lumilux CD 397 (fluorescent yellow) is present, then under UV irradiation an orange color (red+yellow) is generated “next to” a (pure) yellow color.

It is also conceivable, in particular for the replication layer, the partial lacquer layer, the mask layer and/or one or more color lacquer layers, to use a lacquer that forms an IR-active layer.

The conversion of infrared excitation radiation into visible light is referred to as anti-Stokes luminescence or up-conversion. A layer having such properties is preferably referred to here as an IR-active layer. The following materials can convert IR radiation into the visible spectral range by multi-stage excitation processes, and are in particular added to the IR layer:

### Fundamental Lattice:

oxidic compounds (e.g. Y₂O₃, ZrO₂, La₂MoO₆, LaNbO₄, LiYSiO₄), oxyhalides (e.g. YOCl, LaOCl, LaOBr, YOF, LaOF), oxysulfides (e.g. Y₂O₂S, La₂O₂S, Gd₂O₂S, Lu₂O₂S) and fluorides (e.g. YF₃, LaF₃, LiYF₄, NaYF₄, NaLaF₄, BaYF₅). To increase the luminescence yield, the rare-earth combinations Yb³⁺—He³⁺, Yb³⁺—Tm³⁺ and Yb³⁺—Ho³⁺ are normally used as radiation centers in the anti-Stokes luminescent substances. Furthermore, the following materials can be used as IR-VIS radiation converters (conversion of IR radiation into visible radiation (VIS)): SrF₂:Er³⁺, YF₃: Yb³⁺, Tb³⁺′ or CaF₂:Eu²⁺.

It is advantageous if the proportion of luminescence and infrared raw materials in relation to the binder is between 0.01% to 20%, preferably between 0.05% and 15%, more preferably between 0.1% and 10%, wherein, in particular, as binder, use is made of polyacrylates, polyurethanes, epoxies, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ethers, vinyl acetate, alkyl vinyl ethers, conjugated dienes, styrene, acrylates and/or copolymer resins or mixtures thereof.

The fluorescence layer or luminescence layer or IR-active layer may in each case be formed as a separate layer in the layer structure. Furthermore, a fluorescent, luminescent or IR-active component may be added to the color lacquer and/or to the replication layer and/or to the base layer.

In particular, it is conceivable that the replication layer, the partial lacquer layer, the mask layer and/or one or more color lacquer layers are formed as a fluorescence layer, a luminescence layer and/or an IR-active layer.

It is also possible to add to the layer structure an additional semitransparent metallic layer which appears in a first visually identifiable color when observed under vertical illumination and appears in a second visually identifiable color when observed under transmitted light. An example is the material with the name Lumogen OVD 7001M from BASF (Ludwigshafen, Germany). Here, the color gold appears in a view in reflection, and the color blue appears in a view in transmission. In particular, a gold/blue color change takes place, preferably upon a change from a view in reflection to a view in transmission.

Preferably, the additional semitransparent metallic layer has a monodisperse metal with a size from 15 nm to 1000 nm, for example silver that is dispersed in a lacquer, in particular with a layer thickness from 15 nm to 1 μm.

Product features mentioned above may self-evidently be used equivalently in a method, or method features that have been mentioned may be used in the product. A device may be designed or configured such that one of the stated method features can be carried out by means of the device.

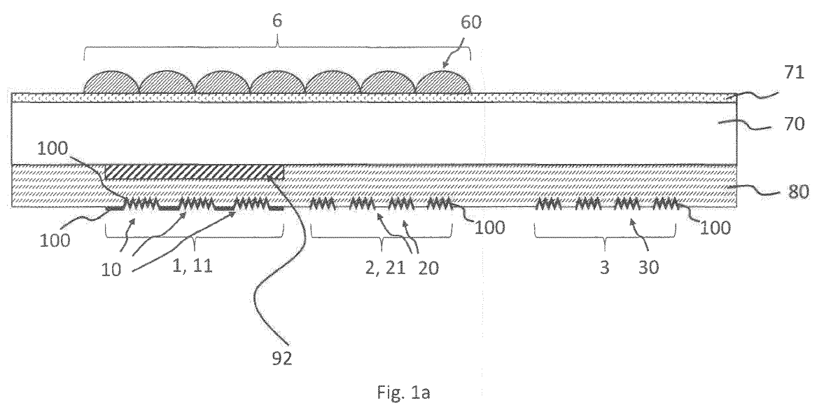

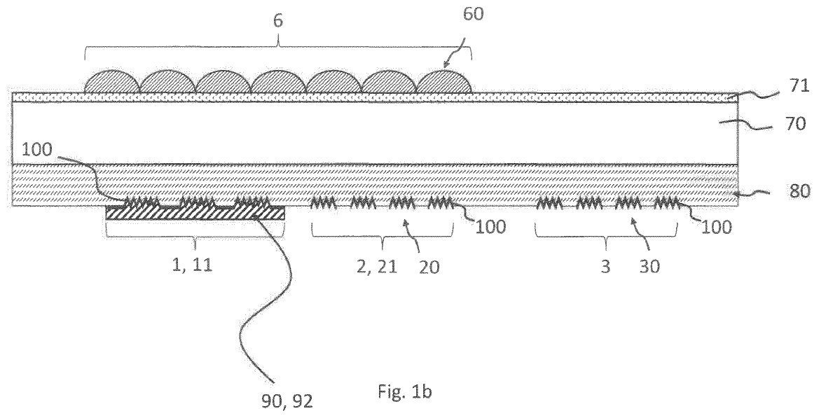

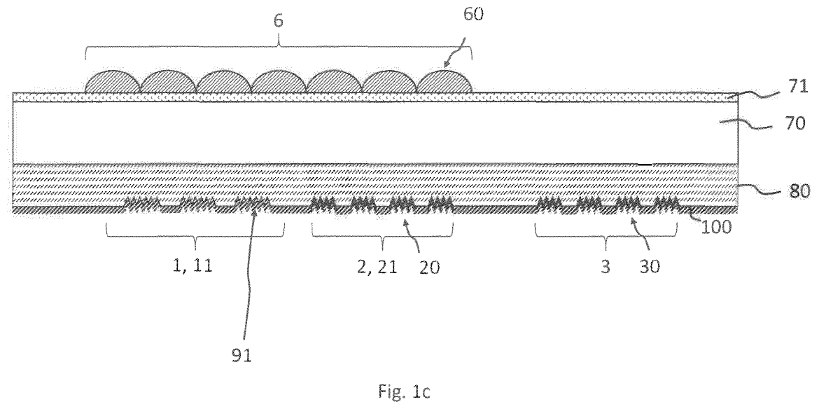

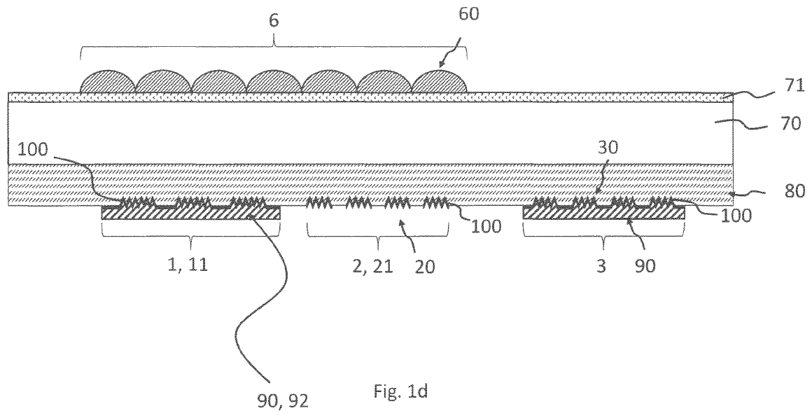

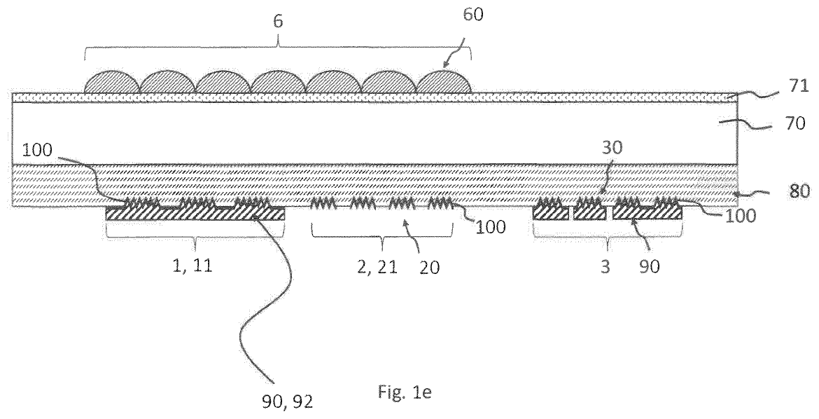

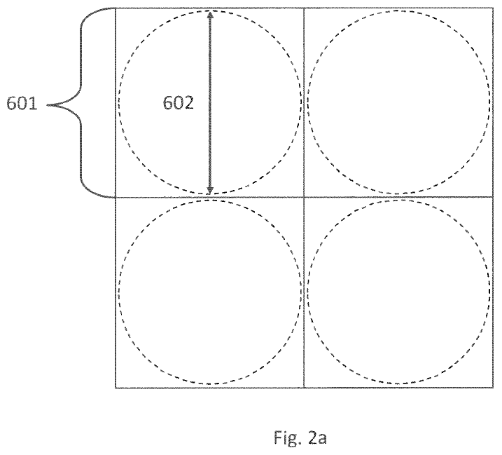

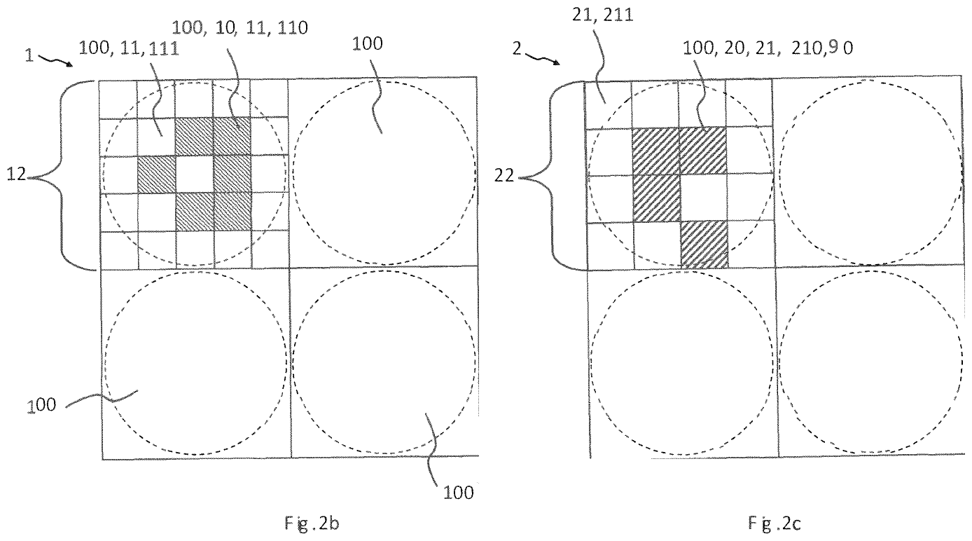

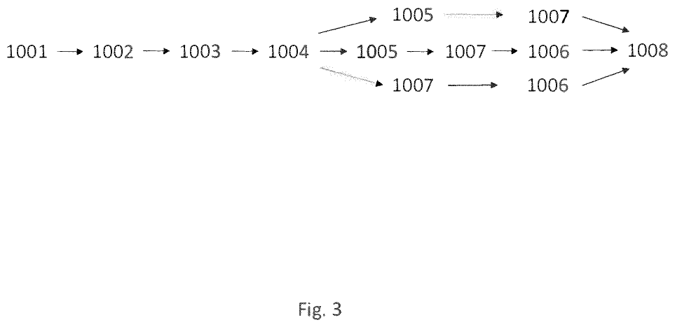

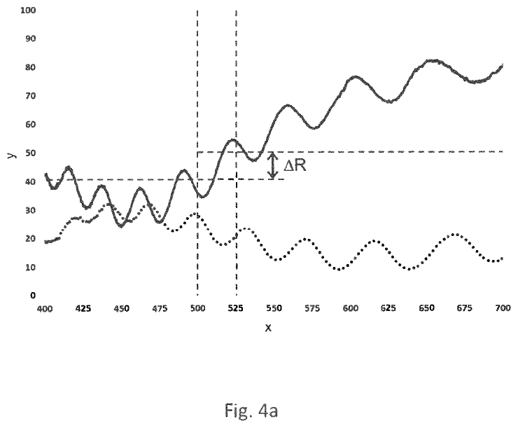

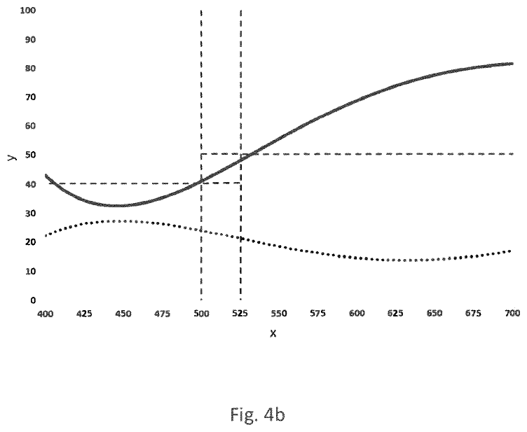

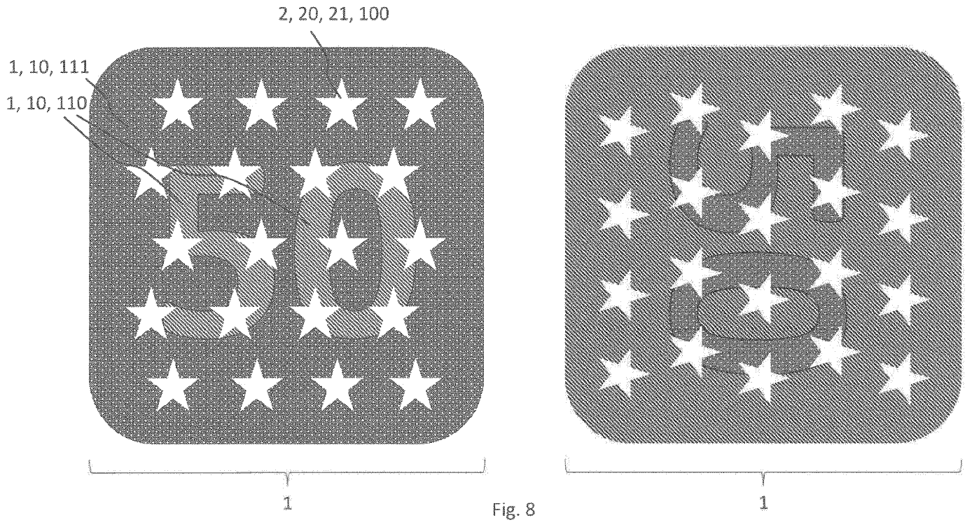

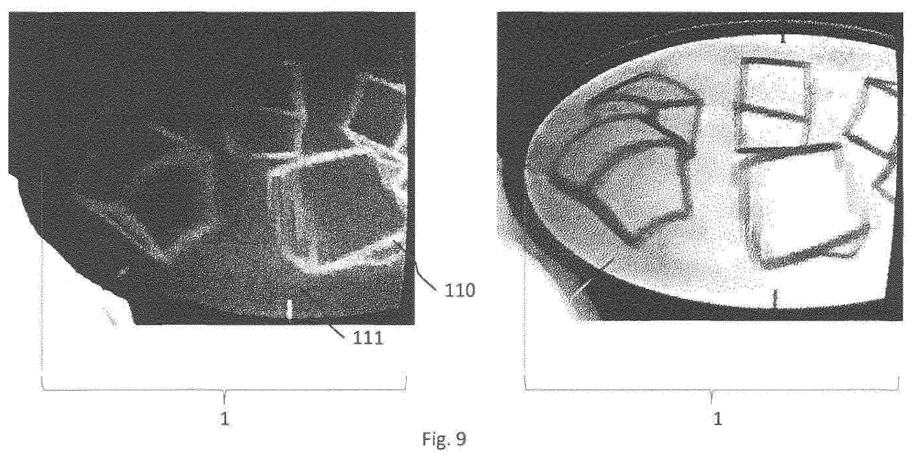

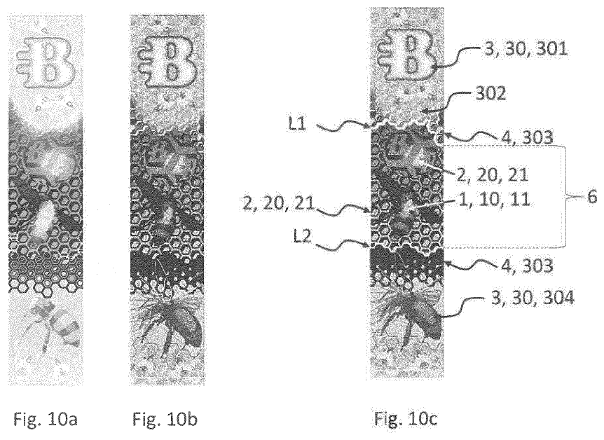

The invention will be discussed by way of example below on the basis of a plurality of exemplary embodiments and with reference to the appended drawings. The exemplary embodiments shown are therefore not to be understood as limiting.

| | |
|---|---|
| FIG. 1a, 1b, 1c, 1d | are schematic sectional illustrations of a multilayer |
| and 1e | body. |
| FIG. 2a, 2b and 2c | are schematic illustrations of microlens arrays and |
| | image elements. |
| FIG. 3 | is a schematic illustration of a method. |
| FIG. 4a and 4b | show example reflection spectra of structures or |
| | image elements. |
| FIG. 5, 6, 7a, 7b | are schematic plan views of an exemplary multilayer |
| and 8 | body. |
| FIG. 9 | shows, by way of example, a first region from |
| FIG. 10 | different viewing angles. |
| | shows, by way of example, a multilayer body in |
| | plan view. |

FIG. 1a, FIG. 1b, FIG. 1c and FIG. 1d are schematic sectional illustrations of an exemplary multilayer body. The multilayer body schematically shown in FIG. 1a, FIG. 1b, FIG. 1c and FIG. 1d is in particular a security element.

Such a multilayer body comprises a spacer layer 70. The spacer layer 70 has a first side and a second side situated opposite the first side. On the first side, a microlens array 60 is arranged in a microlens region 6. The microlenses preferably have a lens focal length of between 10 μm and 50 μm. An adhesion promoter layer 71 is optionally arranged on the first side or at least between the microlens array 60 and the spacer layer 70.

A replication layer 80 is arranged on the second side.

First relief structures 10 are arranged in the replication layer 80. The first relief structures are assigned to a plurality of first image elements 11, which are arranged in a first region 1 of the microlens array 6. The image elements 11 are also shown by way of example in FIG. 2b. The first relief structure 10 provides structure-based colors and/or color effects. Structure-based color effects may be achieved for example by means of golden mirror structures and/or black mirror structures, in particular the layers and structures described with regard to FIGS. 4a and 4b.

In the first region 1 and/or one or more first subregions of the first region 1, the first image elements 11 are formed at least by the partial metal layer 100 arranged on the first relief structures 10. Here, at least one relief structure of the first relief structures 10 may comprise a first subwavelength grating, wherein the first subwavelength grating is preferably assigned to one or more first image element regions 110 of the first image elements 10. It is also possible that one or more further image element regions 111 of the first image elements 11 comprise mirror surfaces, as can be seen for example in FIG. 1a in the regions adjoining the relief structures 10. It is for example also possible that the first relief structures 10 comprise a second subwavelength grating, which differs from the first subwavelength grating, in the first region 1 instead of or in addition to the mirror surfaces. The second subwavelength grating is preferably also assigned to the first image elements 11, in particular to the one or more further image element regions 111 of the first image elements 11.

The relief depth t of a subwavelength grating, in particular of the first and/or second subwavelength grating, is preferably selected to be between 50 nm and 400 mm, in particular between 80 nm and 350 nm, and particularly preferably between 100 nm and 300 nm. The subwavelength grating, in particular the first and/or second subwavelength grating, preferably has an asymmetrical profile shape. It has been found that asymmetrical profile shapes of the subwavelength gratings can be advantageous, in particular because greater degrees of color saturation can hereby be achieved.

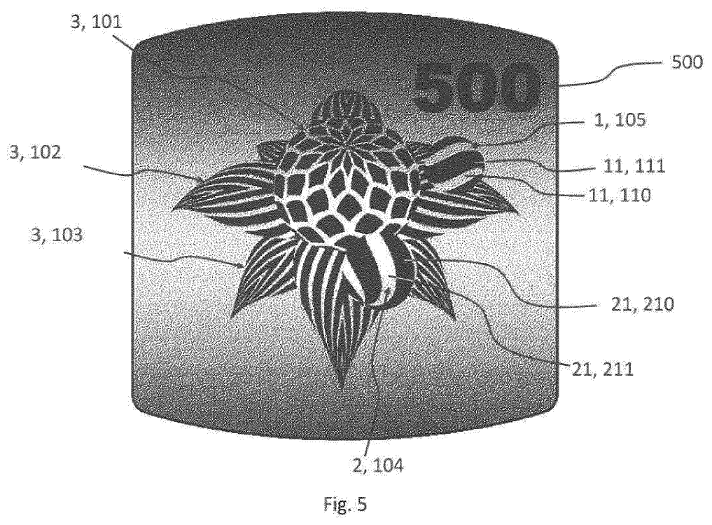

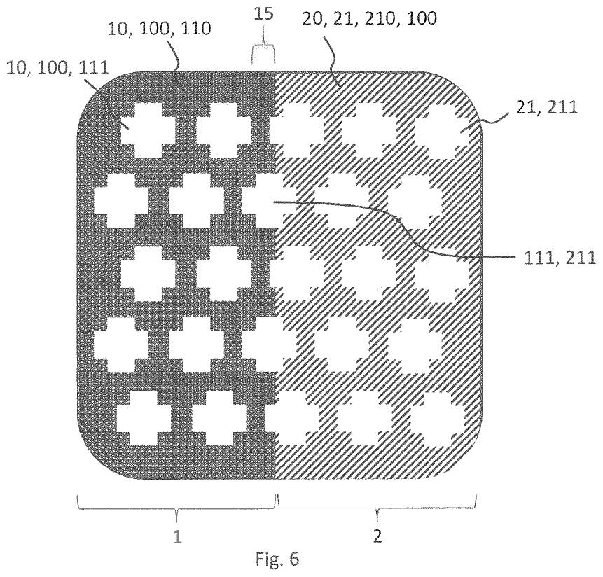

The first relief structures 10 are in particular designed so as to generate or provide structure-based contrast differences and/or structure-based color differences within the first image elements 11. As shown by way of example by FIGS. 5 and 6, it is thus possible in particular within for one or more images, which are visible preferably in the first region 1 through the microlens array 60 at one or more viewing angles, to be generated or provided by the first image elements 11, in particular by first image element regions 110 and further image element regions 111 of the first image elements 11.

It is possible that the partial metal layer 100 is molded on the first relief structures 10 in the first region 1. It is also possible for an HRI layer 91, shown by way of example in FIG. 1c, to be molded on the first relief structures 10. The partial metal layer 100 may extend beyond the relief structures 10, as can be seen by way of example in FIG. 1a. The mirror surfaces can thus be provided adjacent to the relief structures 10. Said mirror surfaces are in particular assigned to further image element regions 111 of the first image elements 11. Here, the relief structures 10 have for example a black mirror structure or a golden mirror structure.

The replication layer 80 also has second relief structures 20. As can be seen in particular in FIG. 1d and FIG. 1e, it is also possible for a partial lacquer layer 90 to be arranged on the replication layer 80. It is also possible for a multilayer body to have both the second relief structures 20 and the optional partial lacquer layer 90. The second relief structures 20 and optionally the partial lacquer layer 90, in particular if the partial lacquer layer 90 remains in the second region 2 and is not removed again, are assigned to a plurality of second image elements 21. The second image elements 21 are shown by way of example in FIG. 2c. The second image elements 21 are arranged in a second region 2, which is preferably separate from the first region 1, of the microlens region 6.

A partial metal layer 100 is applied to the replication layer 80. In the second region 2, a contour of the partial metal layer 100 follows a contour of the second relief structures 20 and optionally of the partial lacquer layer 90, and forms a contour of the second image elements 21. The optional partial lacquer layer 90 is preferably applied to the metal layer 100.

The contours of the partial metal layer 100 and of one or more of the second relief structures 20 and optionally of the partial lacquer layer 90, if the partial lacquer layer 90 remains in the second region 2 in the finished multilayer body, are preferably arranged in register, preferably in perfect register, relative to one another. Such a multilayer body can be obtained in particular by means of the method according to the invention, preferably the demetallizing operation in the method. For example, the second relief structure 20 is used as a mask, in particular exposure mask, during the demetallizing of the metal layer, as can be seen in particular in FIGS. 1a and 1b. It is possible in particular that, preferably using a positive or negative photoresist lacquer, the metal layer is removed in regions having the second relief structure 20 used as an exposure mask for the photoresist lacquer, or the metal layer is removed in regions without the second relief structure 20 used as an exposure mask for the photoresist lacquer.

The partial metal layer 100 is either not provided in the first region 1, as shown by way of example by FIG. 1c, or is provided over the full area, as shown by way of example in any one of FIGS. 1a, 1b, 1d and 1d, in particular such that the contour of a plurality of the first image elements 11 is independent of the contour of the partial metal layer 100.

The partial lacquer layer 90 or a mask layer 92 is preferably applied over the full area in the first region 1, such that, in the method, in particular during the demetallizing operation, the partial metal layer 100 is maintained there, and in the multilayer body is arranged in register with, in particular with a perfect register in relation to, the first region and the partial metal layer 100 in the first region. The mask layer 92 may for example be applied between the spacer layer 70 and the replication layer 80, as can be seen by way of example in FIG. 1a, wherein the mask layer preferably comprises UV blockers. It is also possible to apply the mask layer 92 or in particular the partial lacquer layer 90 as a mask layer 92 to a side of the metal layer facing away from the replication layer 80, as illustrated by way of example by FIG. 1b, wherein the mask layer is preferably formed as a resist lacquer.

It is possible that, as illustrated by way of example by FIG. 1b, a third region 3 is provided, which may preferably be situated at least partially outside the microlens region 6. In the third region 3, the partial metal layer 100 may be maintained by virtue of third relief structures 30 that are provided in the replication layer 80 also being used as a mask during the demetallizing of the metal layer. For this purpose, it is advantageous for at least one relief structure of the third relief structures 30 to have an aspect ratio of greater than 0.3, preferably greater than 0.5. Preferably, a contour of the partial metal layer after the demetallizing operation follows a contour of said at least one third relief structure 30, advantageously with a perfect register between the metal layer and third relief structure 30. Since it is thus possible, for example, to generate a region having an optically variable effect outside the microlens region 6, as well as microimage information based on structure-based color effects and further microimage information using the second relief structure 20 as a mask, it is possible in particular to realize a particularly large number of different security features in a particularly small number of working steps, thus greatly increasing protection against forgery with relatively little outlay.

It is possible for the third relief structures 30 to be configured so as to act as a mask during the demetallizing operation. In particular if the third relief structures 30 are optionally used as a mask during the demetallizing operation, it is advantageously the case that at least one relief structure of the third relief structures 30 has an aspect ratio of greater than 0.3, preferably greater than 0.5. Preferably, a contour of the partial metal layer after the demetallizing operation follows a contour of said at least one third relief structure 30, advantageously with a perfect register between the metal layer and third relief structure 30. For example, in particular for a multilayer body as shown in FIG. 1b, the partial lacquer layer 90 may be provided in the third region 3 and formed as a photoresist lacquer, which is removed correspondingly to the third relief structures 30 prior to the demetallizing operation and which, during the demetallizing operation, protects the metal layer such that the partial metal layer 100 covered by the partial lacquer layer 90 in the third region is maintained. The rest of the partial lacquer layer 90 in the third region 3 can subsequently be removed, such that, in particular, a third region 3 as shown by way of example in FIG. 1b can be obtained, which exhibits a perfect register of third relief structures 30 in relation to the partial metal layer 100 in the third region 3. For example, the partial lacquer layer 90 in the third region 3 may be a photoresist lacquer, which is removable correspondingly to the third relief structures 30.

As illustrated by way of example by FIG. 1d and FIG. 1e, it is also possible for the partial lacquer layer 90 to be used as a mask, in particular exposure mask, during the demetallizing of the metal layer, preferably in a third region 3, which is situated at least partially within and/or at least partially outside the microlens region 6. The partial lacquer layer 90 preferably serves, both in the third region 3 and in the first region 1, as a mask during the demetallizing of the metal layer. Here, the third relief structures 30 may be designed so as not to act as a mask during the demetallizing operation, whereby, for example, the third regions 3 shown in FIG. 1d and FIG. 1e can be obtained. It is also conceivable that, as illustrated by way of example by FIG. 1e, the partial lacquer layer 90 or a further partial lacquer layer instead of the partial lacquer layer 90 in the third region 3 is arranged, preferably printed, as an etching resist only in certain regions in the third region 3, that is to say in particular in register with the third relief structures 30 with a defined register tolerance. Subsequently, during the demetallizing operation, the metal layer may be removed in the third regions 3, correspondingly to those regions which are not covered by the partial lacquer layer 90.

Instead of the partial lacquer layer 90 in the third region 30, it is also possible for some other partial lacquer layer which differs from the partial lacquer layer 90 in the first region 1 to be provided, which other partial lacquer layer is in particular formed correspondingly to the partial lacquer layer 90 described above with regard to the third region 3.

The second relief structures 20 have for example a diffractive cross grating, in particular with a depth of 2.5 μm and a width of 2.5 μm, that is to say a high aspect ratio of 1. Such an aspect ratio can advantageously be easily utilized during an exposure in order to use the second relief structures as a mask during the demetallizing operation, in particular by virtue of one or more photoresist lacquers being more intensely exposed through the metal layer in regions having such an aspect ratio than in other regions. It is possible for the at least one relief structure of the second relief structures 20 to be assigned to the second image elements 21, and to have an aspect ratio of greater than 0.3, preferably greater than 0.5. Preferably, a contour of the partial metal layer 100 after the demetallizing operation follows a contour of said at least one second relief structure of the second relief structures 20. Preferably, said at least one relief structure of the second relief structures 20 is assigned to first image element regions of the second image elements. It is possible that, in the second region 2, further image element regions of the second image elements are provided, which have or are assigned one or more of the following structures: mirror surfaces, statically and/or isotropically matte surfaces, optically variable structures, in particular diffractive structures, having an aspect ratio of less than 0.25, for example having a grating structure having a grating depth of 0.15 μm and having a width, that is to say grating period, of 1 μm, that is to say having a low aspect ratio of 0.15. At least one of the second relief structures is preferably designed such that it can be used as a mask during the demetallizing of the metal structure.

With regard to the materials and structures of the individual layers of the multilayer body, reference is made in particular to the statements above.

FIG. 2a shows, by way of example and in a plan view, a detail of a region having a microlens array. The focal length of the microlenses is for example 30 μm or the aforementioned values. As shown by FIG. 2a, it is possible for the microlens array to have a period having the interval 601. The microlenses may also have a diameter 602. With regard to preferred values and geometries, reference is made in particular to the statements above. In particular, the diameter 602 of the microlenses is smaller, preferably in a range from 5 μm to 0 μm smaller, preferably no more than 1 μm smaller, than the period 601.

The exemplary illustration shows, in particular, a period of 25 μm and a lens diameter of 24 μm. The microlenses thus have a minimum spacing of 1 μm.

FIGS. 2b and 2c each show, by way of example, a detail of one image element group in the first region 1 and in the second region 2. The period of the image element groups preferably corresponds to the period 601 of the microlenses. It is thus possible that the image element groups in particular seamlessly adjoin one another. The microlenses however advantageously have a small spacing.

FIG. 2b shows, by way of example and in a plan view, a detail of a first region 1 having a microlens array. The contour of the first image elements 11, illustrated by way of example with hatching, and of the further first image elements 11 surrounding these is determined in particular by the fact, preferably determined only by the fact, that the first relief structure 10 in the regions shown with hatching, which in particular form first image element regions 110 of the first image elements 11, has different properties than structures in surrounding regions, which in particular form further image element regions 111 of the first image elements 11, wherein, however, the partial metal layer 100 is present over the full area in the image element group, or no metal layer is provided. The number of image elements in FIG. 2b and FIG. 2c is shown as being relatively low for illustrative purposes. In particular, however, the number of first image elements in an image element group is greater than the number of second image elements in an image element group.

FIG. 2c shows, by way of example and in a plan view, a detail of a second region 2 having a microlens array. A contour of the second image elements 21 can be seen in particular at the transition from first image element regions 210 of the second image elements 21 to further image element regions 211 of the second image elements 21.

Within the contour, that is to say in the regions 210 shown by way of example with hatching, the partial metal layer 100 is for example present. It is also conceivable for the partial lacquer layer 90 to alternatively or additionally be present there. It is for example also possible that the partial metal layer 100 is not present in the first image element regions 210, and/or that the partial metal layer 100 and/or the partial lacquer layer 90 is present only in the further image element regions 211. In order that a contour exists, the partial metal layer 100 or the partial lacquer layer 90 is in particular not present over the full area in the image element group.

The image elements are in particular formed by the partial metal layer and by optionally provided layers, such as a replication layer having a relief structure and/or colorants, color layers etc. The image elements are preferably visible, in particular through the microlenses, in a view directed from the side of the microlens array onto a plane spanned by the multilayer body. If the optical effect of the microlenses is disregarded, the image elements and in particular image element groups have corresponding shapes and sizes as shown by way of example in FIG. 2b and FIG. 2c.

It is also possible that the first region 1 and/or second region 2 are made up of a plurality of, in particular separate, subregions. It is also conceivable that an image element group has both first image elements 11 and second image elements 21.

The method according to the invention for producing a multilayer body, in particular a security element, comprises the following steps, which are illustrated by way of example in FIG. 3:
Providing 1001 a spacer layer 70 having a first side and having a second side situated opposite the first side.
Providing or generating 1002 a microlens array 60 in a microlens region 6, wherein the microlens array 60 is arranged on the first side of the spacer layer 70.
Providing or generating 1003 a replication layer 80 on the second side of the spacer layer 70.
Providing or generating 1004 first relief structures 10 which are assigned to a plurality of first image elements 11 which are arranged in a first region 1 of the microlens region 6, wherein the first relief structure 10 is designed so as to provide structure-based color effects. Structure-based color effects may be achieved for example by means of the layers described with regard to FIGS. 4a and 4b.
Providing or generating 1005 second relief structures 20, which are assigned to a plurality of second image elements 21, in the replication layer 80, and optionally, in addition to step 1005, providing or generating 1006 a partial lacquer layer 90, which is assigned to a plurality of second image elements 21. The second image elements 21 are arranged in a second region 2, which is preferably separate from the first region 1, of the microlens region 6. The partial lacquer layer is preferably assigned at least in certain regions to the same second image elements 21 as the second relief structures 20, if the partial lacquer layer 90 is present in the second region 2 in the finished multilayer body and has been used for example as an etching resist during the demetallizing operation. The partial lacquer layer may also extend into or be present in the first region 1 and/or the third region 3.
Providing or generating a metal layer 1007 on the replication layer 80. If a partial lacquer layer is generated or provided, then step 1007 is preferably carried out before step 1006. If a second relief structure is generated or provided, then step 1005 is preferably carried out before step 1007. Step 1005 is particularly preferably to be carried out simultaneously or in one working step with step 1004, in particular in order to generate the first relief structures 10 and the second relief structures 20 simultaneously or in one working step.
Demetallizing 1008 the metal layer using the second relief structure 20 and/or the partial lacquer layer 90 as a mask, such that a partial metal layer 100 is obtained, wherein, in the second region 2, a contour of the partial metal layer 100 follows a contour of the second relief structures 10 and/or of the partial lacquer layer 90 and forms a contour of the second image elements.

After the demetallizing operation and in particular in the multilayer body, in particular security element, thus produced, the partial metal layer 100 is either maintained over the full area in the first region 1, is removed there during the course of the demetallizing operation. It is also conceivable that the metal layer is not provided in the first region 1 in the first place in step 1007.

In particular, in the first region, the contour of a plurality of the first image elements 11 is thus independent of the contour of the partial metal layer 100.

Steps 1001 to 1004 and 1008, preferably also 1005 and 1006, are preferably carried out in the sequence depicted in FIG. 3, wherein, in particular in the case of the generation 1006 of a partial lacquer layer 100, the metal layer is applied in accordance with step 1007 before this generation step, and/or step 1006 is carried out after the generation of the metal layer in step 1007 step 1006 is carried out prior to the demetallizing operation 1008.

Yet further relief structures may optionally advantageously also be arranged in or formed into the replication layer 80, preferably simultaneously or in one working step with the formation of the first and second relief structures. As shown by way of example in FIGS. 1a, 1b, 1c, 1d and 1e, a third region 3 having third relief structures 30 may optionally also be provided or formed in the replication layer 80. The third relief structures may in particular form a Kinegram®.

The method for producing the multilayer body may in particular have one or more of the following steps, preferably in the stated sequence:
Providing the spacer layer 70, which is in particular a carrier layer. The spacer layer or carrier layer 70 preferably has or consists of PET.
Providing a primer 71 on the first side of the spacer layer 70 or applying a primer 71 to the first side of the spacer layer 70. A primer is in particular an adhesion promoter layer.
Coating the second side of the spacer layer 70 with the mask layer 92 in the form of a lacquer layer which blocks UV radiation, and which may optionally be colored. The metal layer in the first region can thus be protected against demetallization, such that the partial metal layer 100 is present or formed preferably congruently with the mask layer 92, in particular in a view directed perpendicularly onto a plane spanned by the multilayer body.
Coating the second side of the spacer layer 70, in particular of the spacer layer 70 and of the mask layer 92, with the replication layer 80, preferably with an application weight in the range from 0.5 g/m² to 4 g/m².
Replicating the first relief structures 10 and the second relief structures 20 and optionally further relief structures, for example the third relief structures 30, into the previously applied replication layer 80 on its side facing away from the spacer layer 70. The replication is performed in particular by thermoplastic molding or by UV molding.
Coating the spacer layer 70, in particular the primer, on the first side with a further replication layer, in particular with an application weight in the range from 5 g/m² to 10 g/m².
Replicating the microlens array 60 in the microlens region 6 into the further replication layer applied to the first side of the spacer layer 70. The replication is performed in particular by thermoplastic molding or UV molding. The microlenses are preferably positioned in register with one or more of the following layers or elements: the first image elements 11 and/or second image elements 21, the partial lacquer layer 90, the mask layer 92, in particular the mask layer 92 with UV blockers. The microlens region 6, which is in particular spanned by the microlens array 60, in particular in a view directed perpendicularly onto a plane spanned by the multilayer body, is preferably applied over the full area or only in parts, in particular in the form of a motif. It is also possible for the microlens array to be made up of a plurality of preferably different partial microlens arrays, as has been described in particular further above.
Applying, in particular by vapor deposition, a metal layer, for example comprising aluminum, to the replication layer 80 that has the first relief structure 10 and the second relief structure 20, whereby, in particular, the color effect and/or contrast generated by the relief structures can be increased or intensified.
Coating the metal layer with one or more photoresist lacquer layers. The photoresist lacquer layers are preferably applied over a full area, in particular in a view directed perpendicularly onto a plane spanned by the multilayer body. The layer thickness of the one or more photoresist lacquer layers preferably lies in a range from 0.5 μm to 1.5 μm, in particular after drying or curing.
Irradiating, in particular exposing, the one or more photoresist lacquer layers through the spacer layer, and preferably through the replication layer and the metal layer from the first side of the spacer layer, in particular using UV radiation. UV radiation is in particular radiation having wavelengths in a range from 100 nm to 380 nm.
Developing and structuring the one or more photoresist lacquer layers. During the structuring operation, in particular either the more intensely exposed or the less intensely exposed regions are removed. It is possible that the partial lacquer layer 90 is maintained here, but this may in particular also be printed on.

It is possible that, in the first region 1, in particular in regions having the mask layer 92, preferably in the form of a printed UV blocker lacquer, as protection, the one or more photoresist lacquer layers are not exposed and are therefore not removed during the structuring operation, and the metal layer is not demetallized during the demetallizing operation. The microimage-microlens effect can thus be generated in this region or these regions preferably by means of, preferably exclusively by means of, the structure-based color effect, in particular contrast difference of different first relief structures 10 or of first relief structures 10 which differ in the first region 1 from surrounding regions, for example mirror surfaces. The adjoining and/or surrounding regions, in particular the second region 2, may be demetallized in accordance with other principles, such that the contrast can be generated therein for example by means of metal and transparency or metal and color transparency and, in particular, a perfect register can advantageously be achieved.

Alternatively or in addition to the coating of the spacer layer 70 with the mask layer 92, it is possible that, after the metal layer has been applied and before the metal layer is coated with the photoresist lacquer layers, a mask layer 92 as a resist lacquer, in particular an etching resist, is applied, in particular printed, over the full area or in parts, in particular in the form of a motif, in the first region 1 onto that side of the metal layer which faces away from the replication layer 80, wherein the resist lacquer, in particular etching resist, protects the metal layer during the demetallizing operation, such that the obtained partial metal layer in the first region is present in regions covered by the resist lacquer, in particular etching resist, in particular is present over the full area in the first region.

It is for example also conceivable for no mask layer 92 to be provided in the first region, and for an HRI layer to be provided in the first region 1, or over the full area in the multilayer body, after the demetallizing operation, as shown by way of example in FIG. 1c. Here, it is preferable for one or more RICS structures to be provided at least in the first region.

The multilayer body is preferably provided on a foil, such that the multilayer body can, by hot stamping or cold stamping or lamination or by embedding into a paper substrate, be applied and/or integrated as a security thread to and/or into a security document, for example in a cylinder mold paper machine or by insert molding decoration or in-mold decoration (IMD) and for example by cutting and punching. For this purpose, it is for example possible for an adhesive layer to be provided on the outermost side facing away from the microlens array.

The adhesive layers used are preferably selected individually or in combination from: single-layer adhesive, multilayer adhesive, water-based adhesive, solvent-based adhesive, solvent-free adhesive, radiation-curable adhesive, thermally activatable adhesive, thermally curable adhesive or combinations thereof.

In particular, the adhesive layer or the adhesive layers are applied by means of a printing process and/or by pouring and/or using a blade. It is also advantageous if the adhesive layer or the adhesive layers are applied at least in parts, preferably over a full area. The layer thickness of the individual adhesive layers is between 0.01 μm and 12.00 μm, preferably between 0.05 μm and 8.00 μm.

In particular, the adhesive layer or the adhesive layers have at least one binder selected individually or in combination from: polyacrylates, polyurethanes, epoxies, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ethers, vinyl acetate, alkyl vinyl ethers, conjugated dienes, styrene, acrylates and/or combinations thereof.

It is also preferable that the lacquer from which the adhesive layer is produced by means of an application process has at least one solvent selected individually or in combination from: water, aliphatic (gasoline) hydrocarbons, cycloaliphatic hydrocarbons, terpene hydrocarbons, aromatic (benzol) hydrocarbons, chlorinated hydrocarbons, esters, ketones, alcohols, glycols, glycol ether, glycol ether acetates and/or combinations thereof. This solvent or solvent mixture is for the most part removed again during the application process.

It is also possible for the adhesive to comprise at least one additive selected individually or in combination from: curing agents, cross-linkers, photoinitiators, fillers, stabilizers, inhibitors, corrosion inhibitors, additives such as flow additives, defoaming agents, deaerating agents, dispersing additives, wetting agents, lubricants, matting agents, rheological additives, pigments, corrosion protection pigments, dyes, waxes and/or combinations thereof. Through suitable selection of fillers or waxes, it is for example possible for the tackiness of the base layer at room temperature to be reduced.

In particular, a thermally activatable adhesive, and/or an adhesive comprising thermoplastic and/or UV-based raw materials, has a solids content in the range from 10% to 100%, preferably from 15% to 35%. The application process on the coating machine can thus be performed with good quality. It is also preferable that the adhesive has a non-tacky surface after drying, in particular at room temperature. It is also advantageous if the raw materials of the adhesive are selected such that the processing temperature during the production of the multilayer body is always higher than the glass transition temperature and lower than the melting point of the adhesive.

A multilayer adhesive layer offers the advantage in particular that excellent adhesion can be achieved even between very demanding surfaces. Furthermore, a multilayer structure makes it possible to realize base layer systems with which a large number of chemical and physical resistances can be achieved. Chemical resistance refers here to the resistance of the adhesive layer to the action of chemicals. The composition of the adhesive layers is preferably selected such that these exhibit adequate resistance to predefined chemicals. It is furthermore advantageous that, in the case of multilayer adhesives, there is adhesion between the individual layers. This is achieved through suitable selection of the adhesive components.

FIGS. 4a and 4b show example reflection spectra which can be provided preferably by relief structures or can be generated in particular together with a metal layer. The reflection spectrum in the case of a view directed perpendicularly onto a structure with a golden appearance, that is to say in particular a golden mirror structure, is illustrated by the solid line. The dashed line shows in particular the reflection spectrum of the so-called black mirror structure, which can preferably be used for very good contrast in relation to the golden mirror structure, in a perpendicularly directed view. A perpendicularly directed view refers here preferably to a view directed onto a plane spanned by a base surface of a relief structure, preferably without a microlens effect. An angle of incidence is measured in particular proceeding from the perpendicularly directed view. FIGS. 4a and 4b show reflection spectra of a relief structure in the form of a golden mirror structure (solid line). The dashed line corresponds to the reflection spectrum of an exemplary black mirror structure, which in particular provides or generates a dark or black color, for direct comparison. In FIG. 4a, the spectra are plotted using the measured original data, whereas FIG. 4b illustrates the same spectra fitted using a 5th order polynomial. The measurements were performed in each case in a wavelength range from 400 nm to 700 nm (x axis), with the obtained values for the reflection being plotted, between 0% and 100%, on the y axis.

It can be clearly seen in particular that the reflection spectrum of the golden mirror structure exhibits greater reflection than the black mirror structure. Furthermore, the reflection of the golden mirror structure is greater in the wavelength range from 525 nm to 700 nm than in the wavelength range from 400 nm to 500 nm. The plotted parameter AR represents the aforementioned preferred difference between the wavelength ranges, and for better clarity is illustrated using the horizontal and vertical dashed lines.

The reflection spectra are preferably determined with perpendicular illumination and observation, preferably using a spectrometer, in particular the AvaSpec-2048 spectrometer from Avantes (Apeldoorn, Netherlands), preferably with a microlens array or only with a relief structure and metal layer without a microlens array. The illumination is provided in particular by means of a white light source, for example via optical fibers using the white light source LS-1 from Ocean Optics (Dunedin, USA; now Ocean Insights), with a color temperature of 3100° K. For the reflection measurement, in particular, an exactly defined directed light beam is directed perpendicularly onto a surface, and the light reflected perpendicularly back is detected by an optical fiber. Said fiber guides the light to the spectrometer, which measures how much light is reflected, and at what wavelength. The reflection is preferably calibrated by standards to 100%. The dark reference is measured here in particular against a matte black surface, and the white balance of the spectrometer is carried out in particular against an aluminum mirror. 100% reflection thus preferably corresponds to the reflection of an aluminum mirror, and 0% preferably corresponds to the reflection of a matte black surface. The measured reflection therefore preferably has a value from a range from 0% to 100%.

The above-stated values for the direct reflection are in particular measured values from reflection spectra in a wavelength range from 400 nm to 700 nm.

In particular for an angle of incidence in the range from 0° to 30°, the image elements with the first subwavelength gratings exhibit reflection of the incident light in at least 75% of the wavelength range from 400 nm to 500 nm which is lower by at least 10% in relation to the reflection in at least 75% of the wavelength range from 525 nm to 700 nm. The image elements with the first subwavelength gratings preferably exhibit reflection of the incident light in at least 70% of the wavelength range from 400 nm to 500 nm which is lower by at least 15% in relation to the reflection in at least 70% of the wavelength range from 525 nm to 700 nm. The image elements with the first subwavelength gratings more preferably exhibit reflection of the incident light in at least 90% of the wavelength range from 400 nm to 500 nm which is lower by at least 15% in relation to the reflection in at least 90% of the wavelength range from 525 nm to 700 nm. The first image elements with the first subwavelength gratings even more preferably exhibit reflection of the incident light in at least 90% of the wavelength range from 400 nm to 500 nm which is lower by at least 20% in relation to the reflection in at least 90% of the wavelength range from 525 nm to 700 nm.

With regard to the design of subwavelength gratings and in particular golden mirror and black mirror structures, reference is made in particular to the statements above.

FIG. 5 shows an example of a plan view of a multilayer body, which preferably constitutes a view of the front side. This is in particular a view of a multilayer body which may be designed for example as described with reference to any one of FIGS. 1a, 1b, 1c, 1d and 1e. The multilayer body shown in FIG. 5 constitutes in particular a view of a plane spanned by the multilayer body. It constitutes in particular a view through the microlens array, such that the microlens effect or the microlens-microimage effect is visible.

As can be seen in FIG. 5, the multilayer body preferably has a plurality of subregions. These are denoted here by way of example as the regions 101 to 105. In this example, the regions 101 to 103 belong in particular to the third region 3, the region 104 belongs to the second region 2, and the region 105 belongs preferably to the first region 1. The multilayer body may be provided, in parts or over the full area, with a colored printed layer, for example with a green-colored layer, behind the partial metal layer 100, in particular behind the partial metal layer 100 as seen in a view directed onto the front side.

The third region 3 may for example have a plurality of subregions, for example in the form of the bud 101 and the leaves in FIG. 5, two of which leaves are denoted as subregions by 102 and 103. Each subregion of the third region 3, in particular each leaf 102, 103, preferably has a different microlens effect, as can be seen for example from the leaves. For example, it is possible for one or more of the subregions, in particular the leaves 102 and 103, of the third region 3 to light up at different tilt angles, and for the security feature to thus in particular be made even more self-explanatory and thus more forgery-proof. The microlens effects of the second subregions 102, 103 advantageously extend in perfect register with the shape of the subregions, in particular the leaves in FIG. 5. In particular, the second image elements 21 in the subregions 102, 103, in particular the leaves, preferably have third relief structures 30, which are arranged in perfect register with the partial metal layer 100, preferably by virtue of said relief structures being used as a mask during the demetallizing operation. The third region 3 is preferably fully overlapped by the microlens region 6. It is also conceivable for one or more subregions of the third region 3 not to be overlapped by the microlens region 6.

In the subregions 102, 103, in particular the leaves 102, 103, there are for example third relief structures, for example diffractive grating structures, which preferably generate structure-based effects, wherein said third relief structures are in particular arranged in perfect register with the second image elements 21 with the partial metal layer 100, that is to say for example the droplet 104. For this purpose, in particular, the second relief structures and the third relief structures are used as a mask during the demetallizing operation, in particular as described above. The subregions, in particular the leaves 102 and 103, preferably light up for example at different tilt angles. For example, the third relief structures 30 in one subregion, for example in a leaf 102, may be grating structures which differ in terms of their grating period from one or more other subregions, for example from the leaf 103. It is possible here that the grating structures have the same azimuth angle. Then, when tilted, in particular when tilted forward and backward, the subregions, in particular the leaves 102, 103, light up in succession, that is to say preferably light up at different defined viewing angles. It is also possible for the third relief structures 30, in particular grating structures, of one or more of the second subregions, in particular the leaves 102 and 103, to differ in terms of their azimuth angle but to preferably have the same grating period. Thus, when tilted, in particular when tilted to the left and to the right, the leaves can light up, in particular light up in succession, that is to say preferably light up at different defined viewing angles.

Microlenses situated over the third relief structures 30, or diffractive structures, can lessen the diffractive effect, inter alia by scattering the light. It is therefore preferable that structure-based effects generated by the third relief structures 30, which are in particular arranged in the microlens region 6, are planar. Here, planar preferably refers to regions, which are coherent as seen by the human eye, of at least 1 mm², more preferably at least 2 mm², particularly preferably at least 4 mm², and more preferably at least 9 mm², in particular in a view directed perpendicularly onto a plane spanned by the multilayer body. In particular, the third relief structure 30 may be applied with a coarser resolution in relation to one or more relief structures of the first and/or second relief structures. The area of the relatively small round droplet 104 may for example be approximately 9 mm².

A further subregion, for example the bud 101, preferably exhibits a movement pattern that differs significantly from the other subregions 102 to 105. The second relief structures 20 preferably have a blaze grating, preferably having a period of greater than 3 μm, in particular in a further subregion, which is shown for example by the bud 101. The blaze grating preferably has azimuth variations. The bud 101 may thus, for example as a contrast point, exhibit an achromatic radial pumping effect, which is generated for example by means of the azimuth variation of the blaze grating with a period of greater than 3 μm as one relief structure of the second relief structures 20.

It is also advantageous if image elements of one or more second subregions are designed to be static and/or to not have an optically variable effect based on microstructures, that is to say preferably to be optically variable in particular only in combination with the microlenses. As a further conspicuous contrast point, it is for example possible for the region 104, which is shown by way of example as a water droplet, to not have an optically variable effect based on microstructures. The corresponding second image elements, in particular further image element regions 211 of the second image elements, which overlap the partial metal layer 100, are provided in these subregions, in particular in this water droplet 104, for example with a mirror surface or with static matte structures. It is thus possible for this subregion, in particular the water droplet 104, to be distinguished purely by microlens effects based on partially metallized image elements.

The first region 1 may for example have one or more first subregions, for example the region 105 shown in FIG. 5 as a water droplet. In these regions, the partial metal layer 100 is present over the full area, that is to say in particular in the image elements 11, which for example comprise or form the first image element regions 110 and the further image element regions 111. For this purpose, the mask layer 92 may for example be used during the demetallizing operation. Owing to different properties of a plurality of the first relief structures 10 of the further image element regions 111, for example, an optically variable effect can be seen which exhibits movement patterns and/or color changes when the multilayer body is tilted. Through different design of the structures of the first image element regions 110 and of the further image element regions 111, it is for example also possible to reproduce contours of motifs, despite the partial metal layer 100 that is provided over the full area in the first region 1, such as in the droplet 105 shown as an example. Thus, instead of an item of image information generated by means of the partial metal layer 100 and second relief structures 20, as is the case for example in the leaves 102 and 103 and the droplet 104, the second water droplet 105 may have an item of image information with structure-based color effects. For example, an item of image information formed in particular by first image element regions 110 and further image element regions 111 of the first image elements may, like the item of image information shown by way of example in the regions having said second water droplet 105, be formed from a subwavelength grating, which has a preferably very dark appearance, and a mirror surface. It is also possible for an item of image information formed in particular by first image element regions 110 and further image element regions 111 of the first image elements to be constructed, like the item of image information shown by way of example in the regions having said second water droplet 105, from two subwavelength gratings, wherein one subwavelength grating has a brighter appearance than the other, and in particular one subwavelength grating has a preferably very dark appearance and the other has a preferably bright, for example golden or light blue, appearance. It is thus possible, for example, to generate moving dark lines which move virtually over a metallic golden or metallic light blue droplet 105, whereas the microlens effects in the leaves 102 and 103 consist of silver-colored lines on a colored, for example green, background. In the droplet 105, the first relief structure 10 may thus for example have a first and a second subwavelength grating, which are for example designed as stated above.

A forger must therefore imitate microlens effects having very different appearances in combination with a security feature, which constitutes a major hurdle.

The proportions of the following different variants V1 to V3 for microlens effects are preferably approximately equal.
V1=second image elements 21, in particular further image element regions 211 of the second image elements, with partial metal layer 100 and with mirror surface,
V2=second image elements 21, in particular first image element regions of the second image elements, with partial metal layer 100 and with second relief structures 20, in particular microstructures, for example diffraction gratings and/or achromatic blaze gratings and/or a matte structure, preferably static and/or isotropic matte structure,
V3=first image elements 10 with partial metal layer 100 and with structure-based color effect, for example subwavelength gratings one or more first image element regions 110 and mirror surface one or more further image element regions 111 or subwavelength gratings one or more first image element regions 110 and other subwavelength gratings one or more further image element regions 111.

The difference in the proportions of all variants relative to one another is preferably less than 20% and particularly preferably less than 10%. The difference is preferably determined by the absolute value of the difference between two ratios in relation to the total area of V1 to V3; for example the difference between V1 and V2=|V1/(V1+V2+V3)−V2/(V1+V2+V3)|.

As seen in plan view, a printed layer may be present, preferably with a color gradient, behind the partial metal layer 100, in particular by means of the above-described one or more color lacquer layers, as illustrated in FIG. 5 for example by way of the relatively dark edge and relatively bright center. This may for example involve a relatively dark green at the upper and lower edges, which changes to a brighter green toward the center. It is thus possible for a colored background, for example a green background, to be provided in addition to the partial metal layer 100.

It is also possible for a printed layer that gives rise to a static optical effect to be provided adjacent to the microlens region 6, which for example overlaps the subregions 101 to 105. For example, a print in a black color may be provided, which is illustrated in FIG. 5 as the numeral “500”. This can advantageously be a static reference element for the human viewer, and can in particular make the optically variable effect better perceptible.

FIG. 6 schematically shows an example of a multilayer body in plan view, such that it is possible to see the microlens effect, which is demonstrated in particular by the first image elements 11 and second image elements 21 that are visible through the microlenses. As shown by way of example in FIG. 6, the first region 1 and second region 2 may directly adjoin one another.

In the first region 1 and second region 2, the first image elements 11 and the second image elements 21 and/or the first relief structures 10 and the second relief structures 20, which may be arranged for example as shown in FIG. 6, have in particular one or more of the following structures: subwavelength structures, in particular linear or crossed subwavelength gratings, in particular a black mirror structure.

In the first region 1, the first image elements 11 and/or the first relief structures 10, which may be arranged for example as in FIG. 6, have in particular one or more of the following structures: subwavelength gratings, in particular a golden mirror structure, mirror surface, static matte structures and/or diffractive grating structures, in particular color gratings. The first image elements 11 and the second image elements 21 or the first relief structures 10 and the second relief structures 20 are preferably designed such that, when the multilayer body is tilted, moving motifs formed by first image elements and by second image elements, in particular the illustrated crosses which overlap the first region 1 and second region 2, are visible through the microlens array 60. Here, the first region 1 preferably directly adjoins the second region 2. At at least one viewing angle, at least one motif is formed or provided both from first image elements, in particular further image element regions 111 of the first image elements, and from second image elements, in particular the further image element regions 211 of the second image elements.

In particular, further image element regions 211 of the second image elements 21 are visible in the second region 2, and are visible in the form of motifs, for example the crosses, wherein the motifs move when the multilayer body is tilted. The further image element regions 211 preferably have the partial metal layer 100, wherein the first image element regions 210 of the second image elements 21 do not have the metal layer 100. For example, during the demetallizing operation, the metal layer is removed in the regions of the first image element regions 210 of the second image elements 21, wherein, in particular, the second relief structures 20 of said image element regions 210 are used as a mask.

Here, the second relief structure 20 preferably has a grating which is at least also present in a first subregion 15, adjoining the second region 2, in the first relief structures 10 in the first region 1. The grating is preferably assigned, in the first region 1, to first image element regions 110 of the first image elements 11, and in the second region 2, to first image element regions 210 of the second image elements 21. The further image element regions 211 of the second image elements 21 preferably do not have the grating, and in particular have a mirror surface. When viewed through the microlenses, the further image element regions 211 of the second image elements generate at least one common, preferably closed, motif together with the further image element regions 111 of the first image elements 11. For this purpose, it is for example possible for the further image element regions 111 of the first image elements 11 to have one or more of the following layers or structures: mirror surface, static or isotropic matte structures, and for the further image element regions 211 of the second image elements to have one or more of the following layers or structures: mirror surface, static or isotropic matte structures, and in particular to be designed such that their effect which is visible through the microlenses exhibits the same brightness and the same color at the transition from the first region 1 to the second region 2 at one or more defined viewing angles.

Preferably, the relief structures of the first image element regions 110 of the first image elements 11 and of the first image element regions 211 of the second image elements 21 are identical, and/or the structures or relief structures of the further image element regions 111 and of the further image element regions 211 are identical. In the example shown in FIG. 6, the grating of the first relief structures 10 and second relief structures 20 is preferably present in the image element regions 110 and the image element regions 210, wherein the image element regions 210 are present without a metal layer, because the metal layer has preferably been removed there. Therefore, in the first region 1 in FIG. 6, the grating constitutes in particular a dark background in relation to the crosses, which appear bright. In the first region 1, the partial metal layer 100 is provided over the full area by virtue of the metal layer not having been removed in the first region 1. The further image element regions 111 of the first image elements and the further image element regions 211 of the second image elements preferably have an identical structure, for example a mirror surface or static or isotropic matte structures, and preferably both have the partial metal layer 100.

It is also possible that motifs formed by further image element regions 111 of the first image elements 11, for example the crosses in region 1 in FIG. 6, and motifs formed by further image element regions 211 of the second image elements have an identical or similar color impression. It is thus possible, for example, to give the impression that the same structures are used for the crosses.

The term “closed” is to be understood in particular to mean that at least a coherent visible area of the second image elements 21, in particular the further image element regions 211 of the second image elements, and the first image elements 11, in particular the further image element regions 111 of the first image elements, is formed as seen in a view directed through the microlenses.

Since the second relief structure 20 serves as a mask in the second region 2 and simultaneously as a dark background in the first region 1, a perfect register relative to the second region 2 can be generated. In particular, for this purpose, the metal layer can be protected over the entire first region 1 by a mask layer 92, as in particular described above, during the demetallizing operation. The metal layer can thus for example be removed in the regions without the second relief structure 20. In FIG. 6, the result is therefore a partial metal layer 100 which is arranged such that it is visible over the entire first region 1 and in the region of the second region 2 with the crosses as motifs, and therefore forms, for example, two motifs which are arranged in perfect register with one another.

It is also possible for a color lacquer layer to be arranged in the second region 2, preferably over the full area and/or only so as to overlap the second relief structure 20.

In a preferred embodiment, which can be shown for example by FIG. 6, the partial metal layer 100 is realized in a subregion of the second region 2 with further image element regions 211 of the second image elements having a mirror surface and/or with further image element regions 211 of the second image element having microstructures, for example diffraction gratings and/or achromatic blaze gratings and/or a matte structure, and in the first region 1 the first image element regions 111 of the first image elements are provided with a mirror surface or with structures that appear bright, for example statically or isotropically matte, or color gratings. The second region 2 with partial metal layer 100 may preferably have, as a background, a color layer, in particular of a dark color, for example dark red, like the hatched area in the second region 2 in FIG. 6, for example. The term “as a background” means that the color layer is arranged in particular on a side of the replication layer 80, and preferably of the partial metal layer 100, which faces away from the spacer layer 70. If the color layer is applied over the full area in the second region 2, it is advantageously the case that, in a view directed through the microlenses, in particular only the region without the metal layer is correspondingly visible with color, and seamlessly adjoins the second image elements with the metal layer. The first image element regions 111 in the first region 1 may, as viewed through the microlens array, constitute for example moving motifs or icons (for example white crosses on a red background) or vice versa. The second region 2 may be adjoined by the in particular fully metallic first region 1, which also has image elements with mirror structures or structures that appear bright (for example in isotropically matte form), which are surrounded by a black mirror structure. Owing to the dual function of the black mirror structure, which appears dark in the fully metallized first region 1 and serves as an exposure mask for the demetallizing operation and the presence of the partial metal layer 100 in perfect register with the second relief structure, it is possible for the microlens effects to transition seamlessly and without any offset from the second region 2, which has the partial metal layer 100 in certain regions, into the first region 1, which is covered over the full area by the partial metal layer 100. Thus, in particular when the multilayer body is tilted, the white crosses in FIG. 6 move continuously for example from the left-hand first region 1, which appears dark, into the right-hand second region 2, which has a red background.

This makes it possible to realize intuitively understandable security features which at the same time constitute a very major technical hurdle for forgers.

FIGS. 7a and 7b show schematic plan views of a first region 1 of a multilayer body. The left-hand image shows a first region 1 having first image element regions 110 and second image element regions 111. The first image element regions 110 are for example provided with a mirror surface in order to form the stars, and the further image element regions 111 are provided with black mirror structures in order to form a background. It is thus possible for the bright stars, which move when the multilayer body is tilted, to be displayed on a dark background. FIG. 7b instead shows bright crosses by way of example.

In this example, the partial metal layer 100 is preferably provided over the entire the first region 1.

As illustrated by way of example by the right-hand image, it is possible for the multilayer body to have a translucent color layer, such as the layer 141 that is shown by way of example. It is also possible for the multilayer body to have a plurality of preferably translucent color layers. Said one or more color layers are preferably applied in parts, in particular applied in parts in the first region 1. In particular, the one or more color layers are applied in a plane between the first replication layer 80 and the microlens array 60 or in a plane between the first replication layer 80 and the replication layer provided for the microlens array 60.

By means of the color layers, it is possible in particular for the effect which is visible through the microlenses and generated by the structure-based colors and/or color effects to be made even more intuitively understandable and thus more forgery-proof. If, for example, the first image element regions 110 and the further image element regions 111 are constructed from a mirror surface and black mirror structures in order to form a background, and the one or more color layers are provided, which have for example the forms shown in FIGS. 7a and 7b and may for example be of different colors, then the microlens effect is superposed with the optical effect of the one or more color layers, whereby it is possible in particular to provide an easily explicable security feature. The circles shown in FIG. 7a may for example be formed by a red translucent color print, and the squares may be formed by a blue translucent color print, which color prints, as seen in a view directed onto the front side, lie over the first image elements of the first image element regions 110 and of the further image element regions 111, which, viewed through the microlenses, provide the bright moving stars that are shown by way of example in FIG. 7a.

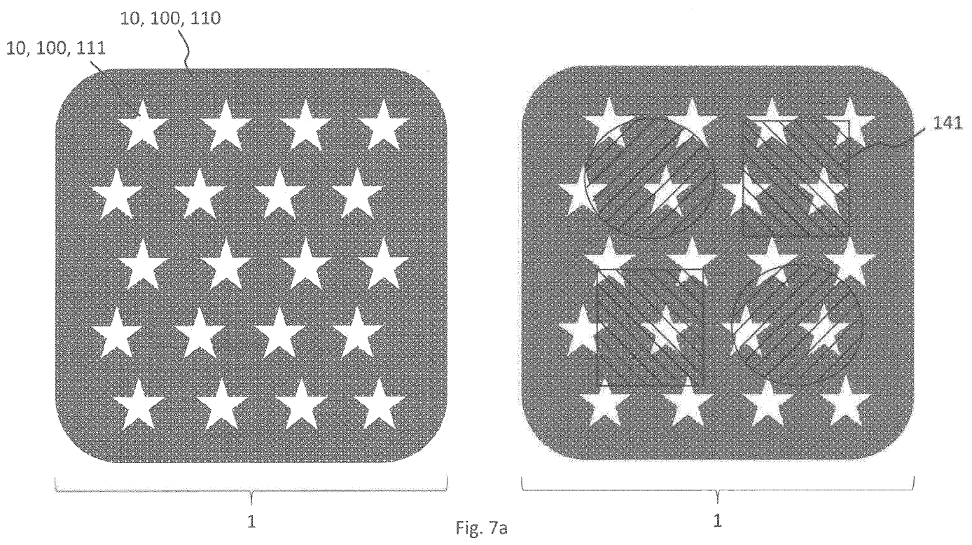

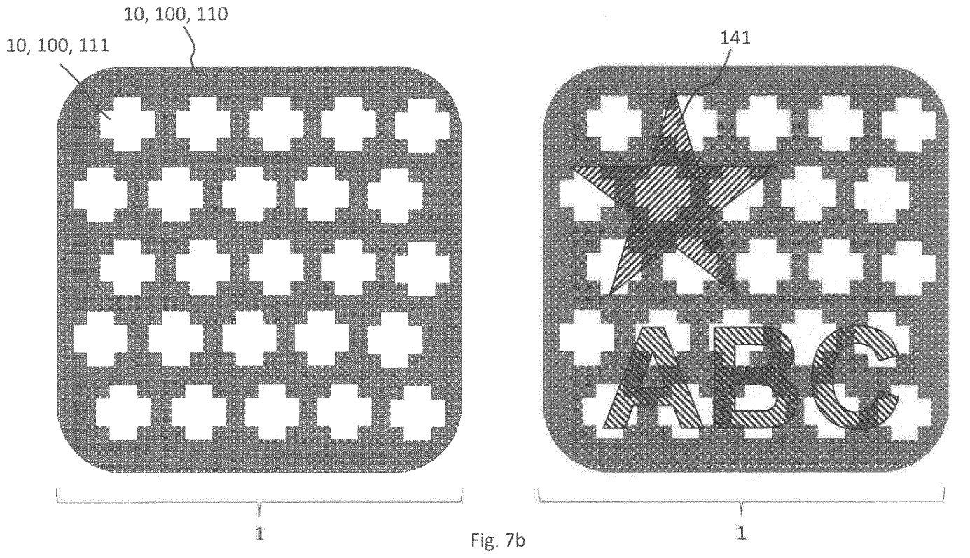

FIG. 8 shows a multilayer body in plan view, in particular through the microlenses. This may in particular be a multilayer body as described with reference to FIG. 1c. When the multilayer body is rotated, the numeral “50” changes its color impression, for example from green to red. The background also changes its color impression when rotated, for example from red to green.

The second region 2 is formed for example by the stars, which have the partial metal layer 100. The partial metal layer 100 is preferably generated in the second region 2 as a result of the demetallizing operation, said partial metal layer being illustrated in FIG. 8 for example in the form of stars. An HRI layer 91, preferably with a thickness in a range from 40 nm to 150 nm, is subsequently preferably applied, in particular by vapor deposition, to the replication layer. It is thus possible for the motifs or icons or the information that is to be presented by the microlens feature to appear metallic/silver-colored. By contrast, the background preferably has the optically variable color effect of the RICS structures. It is thus possible, for example, for the denomination, such as the numeral “50” in FIG. 8, for example in a banknote, to appear in the background in green on a red surface in a direct reflection, and to invert the colors when rotated through 90°. This combination of microlens feature and color rotation effect is particularly forgery-proof. A dark background can be used to increase the color intensity of the RICS effect. It may be implemented for example by means of a partial print with black color. In particular, it is expedient that the first relief structures 10 in the first region 1 have at least one relief structure having a linear subwavelength grating, wherein the linear subwavelength grating has a first diffraction grating, for example to form the background in FIG. 8, and at least one second diffraction grating, for example to form the numeral “50” in FIG. 8, each diffraction grating having a grating period from the range from 100 nm to 500 nm, preferably from 180 nm to 420 nm, wherein the first diffraction grating and the second diffraction grating are designed such that, at a predetermined rotational angle, defined with respect to a rotation about a normal to a plane spanned by the multilayer body, and at a specified illumination angle, a first color is generated by the first diffraction grating and a second color that differs from the first color is generated by the second diffraction grating.

In particular, it has been found that the demetallizing operation can preferably also be carried out with the second relief structures 20 as a mask if, in the first region 1, structures that allow more light to pass through the metal layer than diffraction gratings, for example, are arranged in the replication layer 80. It is thus possible in particular that, in the first region 1, linear subwavelength gratings, which preferably generate the RICS effect in combination with an HRI layer 91, are formed into the replication layer 80. Here, the demetallized regions and/or regions without a metal layer, after having an HRI layer 91, in particular a layer comprising or consisting of TiO₂ and/or ZnS, applied thereto by vapor deposition, exhibit a color effect in a direct reflection or in the zeroth order of diffraction, which is referred to in particular as RICS (Rotation Induced Color Shift). With regard to the design, reference is made in particular to the statements above. One or more RICS structures and/or HRI layers may for example be present at least in the first region 1 or over the entire microlens region 6 or multilayer body outside the second region 2 or over the entire microlens region 6 or multilayer body outside the second relief structures 20 used as a mask, in particular the at least one second relief structure.

FIG. 9 shows, by way of example, the change from a positive to a negative appearance of an optical effect which is visible through the microlenses of the microlens array in the first region 1 in the case of tilting of the multilayer body, preferably to a high degree. In particular, a normal view is shown on the left. The normal view may in particular be a view directed perpendicularly onto a plane spanned by the multilayer body.

In particular, a tilted view, preferably a view tilted to a high degree, preferably with a tilt angle of more than 50° with respect to the normal view, is shown on the right. Here, a background region is formed by a plurality of further image element regions 111 of the first image elements with first relief structures in the form of a black mirror structure, and first image element regions 110 of the first image elements are formed as a mirror surface, wherein the first image element regions 110 of the first image elements are visible through the microlenses as motifs, for example, which in FIG. 9 can be seen for example in the form of edges of three-dimensional objects that resemble an octagon.

It is possible for an optional translucent colored, in particular reddish, color lacquer layer, as also described for example with reference to FIGS. 7a and 7b, to also be provided, preferably between the microlenses and the replication layer 80. The structure-based appearance of the microlens features can thus be made even more intuitively understandable and thus more forgery-proof.

FIGS. 10a, 10b and 10c show, by way of example, a multilayer body, in particular a security element, preferably in the form of a strip. The view is in particular a plan view, which preferably constitutes a view directed perpendicularly onto the plane spanned by the multilayer body, or a view directed onto the front side. FIGS. 10a, 10b and 10b in particular show the same multilayer body, wherein, in FIG. 10c, the outer contour or border of the microlens region 6 is schematically highlighted by a white line.

In the microlens region 6, the optical effect formed by the first image elements 11 in the first region 1 and the second image elements 21 in the second region 2 through the microlens array 60 is visible. This optical effect is for example made up of colors or color effects provided in particular by the first image elements 11, as can be seen in the body of the bee that is shown by way of example, and by motifs provided by the second image elements 21, such as the honeycombs that are shown by way of example. The contour of the motifs formed by the second image elements 21, such as the motifs formed for example as honeycombs, is specified here by the contour of the partial metal layer 100, by virtue of the partial metal layer 100 being present for example only in those regions of the honeycombs in the second region 2 which appear bright or only in those regions of the honeycombs in the second region 2 which appear dark. For example, for this purpose, a relief structure 20 used as a mask is present in the regions which appear dark or the regions which appear bright. The regions which appear bright may thus for example form second image elements 21 with a mirror surface and partial metal layer 100.

The structure-based colors or color effects of the motifs formed by the first image elements 11, such as the motifs formed for example as the body of a bee, are provided by the first relief structures 10. In particular, these color differences or color effects in the first region 1 are provided independently of the contour of the partial metal layer 100 that is present over the full area in the first region 1. Those regions of the body of the bee which appear dark in FIG. 10 may be provided in particular by black mirror structures of the first relief structures 10. The bright regions of the bee may be provided in particular by mirror surfaces in the first image elements 10. In particular, it is possible that, in the multilayer body, one or more color lacquer layers are provided which, in a view directed through the microlens array 6, are arranged at least in certain regions in front of the first relief structures 10 and/or the second relief structures 20 and in particular exhibit color progressions, preferably by screening. These one or more color layers may preferably be applied without being directly assigned to image elements. As illustrated by way of example by FIGS. 10a, 10b and 10c, it is thus possible, for example, to provide the color progression in the body of the bee.

For example, the partial metal layer 100, and additionally in particular second relief structures 20, may be present in the region shown by way of example as a ball. In particular, a color layer which is arranged behind the partial metal layer 100 in a view directed through the microlenses can thus for example impart a colored, in particular yellow, background, preferably with a color progression, to the regions shown by way of example as a ball. With regard to the application of gratings, reference is made in particular to the statements above.

Further motifs or subregions of the motifs in the microlens region 6 may be formed by further motif layers, preferably lacquer layers, such as the wings and legs of the bee.

Further optical effects, in particular in the form of static motifs, are preferably formed in the region outside the microlens region 6, that is to say in particular at least in the fourth region 4, as shown by way of example adjacent to the microlens region 6 in FIGS. 10a, 10b and 10c. These are illustrated for example as honeycombs 303. These further optical effects are preferably provided by means of one or more motif layers which are preferably printed layers and/or applied by means of printing, preferably gravure printing, inkjet printing, offset printing, flexographic printing and/or screen printing. The one or more motif layers may for example be applied to one or more layers selected from spacer layer, preferably on the first and/or second side, first replication layer, second replication layer.

The fourth region 4 is preferably provided so as to overlap and/or adjoin the microlens region 6 and optionally also the third region 3, preferably so as to be continuous between the microlens region and the third region 3, preferably in a view directed perpendicularly onto a plane spanned by the multilayer body. As can be seen in FIGS. 10a, 10b and 10c, it is thus possible to provide a plurality of optically variable and logically interlinked effects.

In particular, the one or more motif layers which in particular provide a static optical effect between the microlens region 6 and the third region 3 may have or be applied with a register tolerance of at most ±1.0 mm, preferably ±0.8 mm, preferably at most ±0.5 mm, from their target position in relation to the microlens region 6. By minimizing register tolerances, protection against forgery can additionally be increased.

As illustrated by FIGS. 10a, 10b and 10c, it is thus possible for one or more motif layers to be arranged in the multilayer body at least in certain regions outside the microlens region 6 and adjacent to the microlens region 6, wherein the one or more motif layers are designed such that they overlap and/or logically supplement and/or complete a first item of image information, which is visible through the microlens array 60 and is provided at least by the first image elements 11 and/or the second image elements 21, with a further item of image information. In particular, the further item of image information is identical to at least a partial item of image information of the first item of image information and/or a scaled partial item of image information of the first item of image information and/or forms a motif together with at least one partial item of image information of the first item of image information and/or a scaled partial item of image information of the first item of image information, wherein the motif preferably constitutes a unit which forms a whole, for example a symbol, a geometrical shape, in particular one or more hexagonal cells of a honeycomb, a logo, an emblem, a portrait, a QR code, a barcode.

In the region inside and/or outside the microlens region 6, that is to say in particular in the third region 3 and/or fourth region 4, it is preferably also the case, as shown by way of example in the upper part of FIGS. 10a, 10b and 10c and in the body of the bee and in the ball, that color lacquer layers are provided for a background color and/or a color progression, preferably in front of and/or behind the partial metal layer 100 as seen in a view directed through the microlenses of the microlens array.

It is possible for one or more motif layers to be arranged so as to overlap the microlens region 6 in certain regions.

The one or more motif layers are thus preferably not assigned to the first or second image elements or other image element groups that would be provided for example for generating a microimage-microlens effect. The one or more motif layers are preferably formed by means of one or more color lacquer layers. They are in particular printed, in particular macroscopic, motif layers, preferably for providing a background color. The motif layers are for example printed with a resolution in a range from 300 dpi to 2540 dpi.

Through the combination of the motif layers with the first and/or second image elements, it is possible to improve the design integration by virtue of motifs being continued in both regions, or supplementing or completing one another. This in particular increases protection against forgery and improves the optical impression.

It is also possible for further optically variable effects to be provided outside the microlens region 6, such as the B-shaped symbol 301 or the stripes on the bees 304. For example, third relief structures 30 may serve for this purpose, which are for example provided with the partial metal layer 100 and are advantageously demetallized at the same time as the partial metal layer 100 in the first region 1 and second region 2. It is also possible for one or more of the third relief structures 30 to be used as a mask for the demetallizing of the metal layer, as can be seen for example in FIG. 1d. It is alternatively or additionally also possible for a lacquer layer which serves as an etching resist to be applied, in particular applied in parts, preferably printed on in parts, in register with the third relief structures 30, and to be used as a mask during the demetallizing of the metal layer, as illustrated by way of example in FIG. 1e. It is also possible for the third relief structures 30 or the further optically variable effects to extend into the microlens region 6. Since these are preferably of planar form, they in particular do not contribute to the microimage-microlens effect generated by the first and second image elements, and instead provide one or more further motifs.

It is also possible, in particular in a view directed onto the front side of the multilayer body, for one or more color layers to be provided behind the partial metal layer 100 so as to extend beyond the partial metal layer 100, as illustrated by way of example by the bee in the lower part of FIGS. 10a, 10b and 10c. There is thus for example a perfect register between differently colored stripes of the bees. It is alternatively or additionally possible, in particular in a view from that side of the multilayer body which has the microlens array 60, for one or more color layers to be provided behind the partial metal layer 100 so as not to extend beyond the partial metal layer 100. It is thus possible to achieve obscuration from one side. It is thus possible to make certain design elements selectively visible from the rear side. This can also lead to an optimization of the design integration. The multilayer body is preferably applied to foils or carriers of security documents in which the rear side is still partially visible after the application process, for example in the case of application to polymer substrates or paper applications with punched-out windows. It is also possible for these one or more color layers which do not extend beyond the partial metal layer to be formed as an etching resist and to be used as a mask during the demetallizing of the metal layer. It is thus possible to realize design elements which appear in different colors when viewed from the front side and from the rear side.

The design variants presented may self-evidently be combined with one another as desired, and do not constitute any limitation.

### LIST OF REFERENCE SIGNS

1 First region
10 First relief structures
11 First image elements
110 First image element regions of the first image elements
111 Further image element regions of the first image elements
101, 102, 103, 104, 105 Subregions
2 Second region
12, 22 Image element groups
15 Subregion
20 Second relief structures
21 Second image elements
210 First image element regions of the second image elements
211 Further image element regions of the second image elements
3 Third region
30 Third relief structure
301, 302 Motif layers
6 Microlens region
60 Microlens array
70 Spacer layer
71 Primer
80 Replication layer
90 Partial lacquer layer
91 Resist lacquer layer
92 Mask layer
100 Partial metal layer
1001, 1002, 1003, 1004, 1005, 1006, 1007, 1008 Method steps

1. A method for producing a multilayer body, wherein the method comprises the following steps:
providing a spacer layer having a first side and having a second side situated opposite the first side;
providing or generating a microlens array in a microlens region, wherein the microlens array is arranged on the first side of the spacer layer;
providing or generating a replication layer on the second side of the spacer layer;
providing or generating first relief structures in the replication layer, wherein the first relief structures are assigned to a plurality of first image elements which are arranged in a first region of the microlens region, wherein the first relief structures are designed so as to generate or provide structure-based colors and/or color effects;
a) providing or generating second relief structures in the replication layer, wherein the second relief structures are assigned to a plurality of second image elements,
wherein the second image elements are arranged in a second region of the microlens region;
providing or generating a metal layer on the replication layer;
demetallizing the metal layer using one or more of the second relief structures as a mask, such that a partial metal layer is obtained, wherein, in the second region, a contour of the partial metal layer follows a contour of the second relief structures and forms a contour of the second image elements,
wherein, in the first region, the partial metal layer is maintained over the predominant part of the full area or over the full area, is completely removed, or is not provided.

2. The method according to claim 1, wherein
the first relief structures are designed so as to generate or provide structure-based contrast differences and/or structure-based color differences within the first image elements and/or within one or more images.

3. The method according to claim 1, wherein
the first relief structures comprise one or more subwavelength gratings.

4. The method according to claim 1, wherein
the first relief structures and/or second relief structures have a relief structure comprising a periodic variation of elevations and depressions in an x direction and in a y direction, wherein the elevations are arranged in succession with a grating period Λ, and the minima of the depressions define a base surface and have a relief depth t.

5. The method according to claim 4, wherein
the grating period A of at least one of the first relief structures is less than a wavelength of 500 nm and/or of light which is visible to the human eye.

6. The method according to claim 1, wherein
at least one relief structure of the second relief structures is assigned to one or more second image elements, and has an aspect ratio of greater than 0.3.

7-8. (canceled)

9. The method according to claim 1, wherein
the first region comprises or consists of a high-resolution microimage region and the second region comprises or consists of a low-resolution region, wherein a smallest image element of the low-resolution microimage region has a minimum width which is greater than a minimum width of a smallest image element of the high-resolution microimage region.

10-11. (canceled)

12. The method according to claim 1, wherein
the first relief structures and/or the first image elements, have a minimum width of at least 1.5 μm.

13. The method according to claim 1, wherein
the first relief structures and/or the first image elements, have at least in certain regions a minimum width of less than 2.5 μm, and the second relief structures and/or the second image elements, have a minimum width of at least 2.5 μm.

14. The method according to claim 1, wherein
the partial metal layer has a minimum width of at least 2.5 μm.

15. The method according to claim 1, wherein,
in the first region and/or one or more first subregions of the first region, the first image elements are formed at least by the partial metal layer arranged on the first relief structures, wherein the first relief structures comprise a first subwavelength grating, wherein the first subwavelength grating is assigned to one or more first image element regions of the first image elements,
wherein the first relief structures comprise a second subwavelength grating which differs from the first subwavelength grating, wherein the second subwavelength grating is assigned to one or more further image element regions of the first image elements, and/or
wherein one or more further image element regions of the first image elements comprise mirror surfaces.

16. (canceled)

17. The method according to claim 1, wherein
the first relief structures are designed such that, when tilted, a motif differs in terms of color from a background in a view directed perpendicularly onto a plane spanned by the multilayer body, wherein, when the multilayer body is tilted, the motif changes from a positive to a negative appearance or vice versa.

18. The method according to claim 1, wherein
the first relief structures in the first region have at least one relief structure having a linear subwavelength grating.

19-20. (canceled)

21. The method according to claim 1, wherein an
HRI layer is provided over part of the area, or over the full area at least in the first region or in the first region and the second region, or is provided over the full area on the multilayer body.

22. The method according to claim 1, wherein,
in the second region, the second image elements comprise first image element regions and further image element regions, wherein, in the first image element regions of the second image elements or in the further image element regions of the second image elements, the partial metal layer is not present in the produced multilayer body, and/or the metal layer is removed during the demetallizing operation.

23-24. (canceled)

25. The method according to claim 1, wherein
the first image elements comprise first image element regions and further image element regions, and the second image elements comprise first image element regions and further image element regions, wherein the first relief structures of the first image element regions of the first image elements are of identical design to the second relief structures of the first image element regions of the second image elements, and/or the structures or first relief structures of the further image element regions of the first image elements are of identical design to the structures or second relief structures of the further image element regions of the second image elements.

26. (canceled)

27. The method according to claim 1, wherein,
in a mirror region in the second region and/or in the one or more second subregions, second image elements comprising the partial metal layer and mirror surfaces are provided,
wherein, in a structure region in the second region and/or in the one or more second subregions, second image elements comprising the partial metal layer second relief structures are provided,
and wherein, in the first region, first image elements having the partial metal layer and having a structure-based color effect are provided.

28-31. (canceled)

32. The method according to claim 1, wherein
the partial lacquer layer is a resist lacquer and is applied at least partially in the first region, wherein, during the demetallizing of the metal layer using a solvent, in particular the resist lacquer protects the metal layer such that a contour of the partial metal layer follows a contour of the partial lacquer layer.

33. The method according to claim 1, wherein
the partial lacquer layer is applied in the first region prior to the demetallizing operation.

34. The method according to claim 1, wherein,
for the demetallizing operation, a photoresist lacquer layer is applied to the replication layer, and is exposed such that the photoresist lacquer layer either can be removed in regions having one or more second relief structures in the second region, or can be removed outside the regions having second relief structures, in the second region.

35. The method according to claim 1, wherein,
after the photoresist lacquer layer has been exposed, the multilayer body is brought into contact with a solvent and the photoresist lacquer layer is partially removed by the solvent.

36. (canceled)

37. The method according to claim 1, wherein
the metal layer in the first region is partially demetallized without using the second relief structure as a mask, and/or wherein, after the demetallizing operation, the partial metal layer in the first region coherently overlaps regions having a relief structure and adjoining regions without a relief structure or having a different relief structure of the first relief structures, and/or is protected during the demetallizing operation by a lacquer layer.

38. The method according to claim 1, wherein
a mask layer is provided in the first region, wherein the mask layer is used as a mask during the demetallizing of the metal layer in the first region.

39-42. (canceled)

43. A multilayer body comprising:
a spacer layer having a first side and having a second side situated opposite the first side;
a microlens array in a microlens region, wherein the microlens array is arranged on the first side of the spacer layer;
a replication layer on the second side of the spacer layer;
first relief structures which are assigned to a plurality of first image elements which are arranged in a first region of the microlens region, wherein the first relief structures provide or generate structure-based colors and/or color effects;
second relief structures, which are assigned to a plurality of second image elements, wherein the second image elements are arranged in a second region of the microlens region;
a partial metal layer applied to the replication layer,
wherein, in the second region, a contour of the partial metal layer follows a contour of one or more relief structures of the second relief structures and forms a contour of the second image elements,
wherein, in the first region, the partial metal layer is not provided or is present over the predominant part of the full area or over the full area.

44. The multilayer body according to claim 43, wherein
the first relief structures are designed so as to generate or provide structure-based contrast differences and/or structure-based color differences within the first image elements and/or within one or more images which are visible through the microlens array at one or more viewing angles.

45-49. (canceled)

50. The multilayer body according to claim 43, wherein
a partial lacquer layer is arranged over the full area in the first region.

51-55. (canceled)
